(19) United States
(12) Patent Application Publication
(10) Pub. No.: US 2011/0178799 A1
(43) Pub. Date: Jul. 21, 2011

(54) METHODS AND SYSTEMS FOR IDENTIFYING SPEECH SOUNDS USING MULTI-DIMENSIONAL ANALYSIS

(75) Inventors: Jont B. Allen, Mahomet, IL (US); Feipeng Li, Baltimore, MD (US)

(73) Assignee: The Board of Trustees of the University of Illinois, Urbana, IL (US)

(21) Appl. No.: 13/001,886

(22) PCT Filed: Jul. 24, 2009
(86) PCT No.: PCT/US2009/051747

§ 371 Date: Mar. 8, 2011

Related U.S. Application Data
(60) Provisional application No. 61/083,635, filed on Jul. 25, 2008.
(60) Provisional application No. 61/151,621, filed on Feb. 11, 2009.

(51) Int. Cl. G10L 15/20; G10L 21/02

(52) U.S. Cl. 704/226; 704/206; 704/233; 704/E21.002; 704/E15.004

(57) ABSTRACT

Methods and systems of identifying speech sound features within a speech sound are provided. The sound features may be identified using a multi-dimensional analysis that analyzes the time, frequency, and intensity at which a feature occurs within a speech sound, and the contribution of the feature to the sound. Information about sound features may be used to enhance spoken speech sounds to improve recognizability of the speech sounds by a listener.

### CROSS-REFERENCES TO RELATED APPLICATIONS

This application claims priority to U.S. Provisional Application No. 61/083,635, filed Jul. 25, 2008, and U.S. Provisional Application No. 61/151,621, filed Feb. 11, 2009, the disclosure of each of which is incorporated by reference in its entirety for all purposes.

### STATEMENT AS TO RIGHTS TO INVENTIONS MADE UNDER FEDERALLY SPONSORED RESEARCH OR DEVELOPMENT

This invention was made with Government support under Contract No. RDC009277A, awarded by the National Institutes of Health. The Government has certain rights in this invention.

### BACKGROUND OF THE INVENTION

Speech sounds are characterized by time-varying spectral patterns called acoustic cues. When a speech wave propagates on the Basilar Membrane (BM), it creates perceptual cues, named events, which define the basic units for speech perception. The relationship between the acoustic cues and perceptual units has been a key research problem in the field of speech perception. Recent work has used speech synthesis as a standard method of feature analysis. For example, speech synthesis has been used to identify acoustic correlates for stops, fricatives, and distinctive and articulatory features. Similar approaches have been used to generate unintelligible “sine-wave” speech, to show that traditional cues, such as bursts and transitions, are not required for speech perception. More recently, the same method has been applied to model speech perception in noise

Speech synthesis has the benefit that features can be carefully controlled. However, synthetic speech also requires prior knowledge of the cues being sought. Thus incomplete and inaccurate knowledge about the acoustic cues has often led to synthetic speech of low quality, and it is common that such speech sounds are unnatural and barely intelligible. Another key issue is the variability of natural speech, which depends on the talker, accent, masking noise, and other variables that often are well beyond the reach of the state-of-the-art speech synthesis technology.

### BRIEF SUMMARY OF THE INVENTION

The invention provides advantageous methods and systems for locating a speech sound feature within a speech sound and/or enhancing a speech sound. The methods and systems may enhance spoken, transmitted, or recorded speech, for example to improve the ability of a hearing impaired listener to accurately distinguish sounds in speech These and other benefits will be described in more detail throughout the specification and more particularly below.

According to an embodiment, a method of locating a speech sound feature within a speech sound may include iteratively truncating the speech sound to identify a time at which the feature occurs in the speech sound, applying at least one frequency filter to identify a frequency range in which the feature occurs in the speech sound, and masking the speech sound to identify a relative intensity at which the feature occurs in the speech sound. The identified time, frequency range, and intensity may then define location of the sound feature within the speech sound. The step of truncating the speech sound may include, for example, truncating the speech sound at a plurality of step sizes from the onset of the speech sound, measuring listener recognition after each truncation, and, upon finding a truncation step size at which the speech sound is not distinguishable by the listener, identifying the step size as indicating the location of the sound feature in time. The step of applying a frequency filter may include, for example, applying a series of highpass and/or lowpass cutoff frequencies to the speech sound, measuring listener recognition after each filtering, and, upon finding a cutoff frequency at which the speech sound is not distinguishable by the listener, identifying the frequency range defined by the cutoff frequency and a prior cutoff frequency as indicating the frequency range of the sound feature. The step of masking the speech sound may include, for example, applying white noise to the speech sound at a series of signal-to-noise ratios, measuring listener recognition after each application of white noise, and, upon finding a SNR at which the speech sound is not distinguishable by the listener, identifying the SNR as indicating the intensity of the sound feature.

According to an embodiment, a method for enhancing a speech sound may include identifying a first feature in the speech sound that encodes the speech sound, the location of the first feature within the speech sound defined by feature location data generated by a multi-dimensional speech sound analysis, and increasing the contribution of the first feature to the speech sound. The method also may include identifying a second feature in the speech sound that interferes with the speech sound and decreasing the contribution of the second feature to the speech sound.

According to an embodiment, a system for enhancing a speech sound may include a feature detector configured to identify a first feature within a spoken speech sound in a speech signal, a speech enhancer configured to enhance said speech signal by modifying the contribution of the first feature to the speech sound, and an output to provide the enhanced speech signal to a listener.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows an example application of a multi-dimensional approach to identify acoustic cues according to an embodiment of the invention.

FIG. 2 shows the confusion patterns of /ka/ when produced by an individual talker according to an embodiment of the invention.

FIG. 3 shows an example of analysis of a sound using a multi-dimensional method according to an embodiment of the invention.

FIG. 4 shows an example analysis of /ta/ according to an embodiment of the invention.

FIG. 5 shows an example analysis of /ka/ according to an embodiment of the invention.

FIG. 6 shows an example analysis of /ba/ according to an embodiment of the invention.

FIG. 7 shows an example analysis of /da/ according to an embodiment of the invention.

FIG. 8 shows an example analysis of /ga/ according to an embodiment of the invention.

FIG. 9 depicts a scatter-plot of signal-to-noise values versus the threshold of audibility for the dominant cue according to embodiments of the invention.

FIG. 10 shows a scatter plot of burst frequency versus the time between the burst and the associated voice onset for a set of sounds as analyzed by embodiments of the invention.

FIG. 11 shows an example analysis of /fa/ according to an embodiment of the invention.

FIG. 12 shows an example analysis of /θa/ according to an embodiment of the invention.

FIG. 13 shows an example analysis of /sa/ according to an embodiment of the invention.

FIG. 14 shows an example analysis of /∫a/ according to an embodiment of the invention.

FIG. 15 shows an example analysis of /δa/ according to an embodiment of the invention.

FIG. 16 shows an example analysis of /va/ according to an embodiment of the invention.

FIG. 17 shows an example analysis of /za/ according to an embodiment of the invention.

FIG. 18 shows an example analysis of /ζ/ according to an embodiment of the invention.

FIG. 19 shows an example analysis of /ma/ according to an embodiment of the invention.

FIG. 20 shows an example analysis of /na/ according to an embodiment of the invention.

FIG. 21 shows a summary of events relating to initial consonants preceding /a/ as identified by analysis procedures according to embodiments of the invention.

FIG. 22 shows a schematic diagram of an example feature-based speech enhancement system according to an embodiment of the invention.

FIG. 23 shows a schematic diagram of an example feature-based speech enhancement system according to an embodiment of the invention.

FIGS. 24-34 show example experimental data for analyses of 96 sounds according to embodiments of the invention.

FIG. 35 is a schematic representation of a logical system to generate an AI-gram that may be used with embodiments of the invention.

### DETAILED DESCRIPTION OF THE INVENTION

It is understood that the invention is not limited to the particular methodology, protocols, topologies, etc., as described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein.

Any numerical values recited herein include all values from the lower value to the upper value in increments of one unit provided that there is a separation of at least two units between any lower value and any higher value. As an example, if it is stated that the concentration of a component or value of a process variable such as, for example, size, angle size, pressure, time and the like, is, for example, from 1 to 90, specifically from 20 to 80, more specifically from 30 to 70, it is intended that values such as 15 to 85, 22 to 68, 43 to 51, to 32 etc., are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Particular methods, devices, and materials are described, although any methods and materials similar or equivalent to those described herein can be used in the practice or testing of the invention. All references referred to herein are incorporated by reference herein in their entirety.

Embodiments of the invention provide methods and systems to enhance spoken, transmitted, or recorded speech to improve the ability a of hearing-impaired listener to accurately distinguish sounds in the speech. To do so, the speech may be analyzed to identify one or more features found in the speech. The features may be associated with one or more speech sounds, such as consonant, fricative, or other sound that a listener may have difficulty distinguishing within the speech. The speech may then be enhanced based on the location of these features within the speech, the relationship of the features to various speech sounds, and other information about the features to generate enhanced speech that is more intelligible or audible to the listener.

Before speech can be enhanced, it may be useful to have an accurate way to identify one or more features associated with speech sounds occurring in the speech. According to embodiments of the invention, features responsible for various speech sounds may be identified, isolated, and linked to the associated sounds using a multi-dimensional approach. As used herein, a “multi-dimensional” approach or analysis refers to an analysis of a speech sound or speech sound feature using more than one dimension, such as time, frequency, intensity, and the like. As a specific example, a multi-dimensional analysis of a speech sound may include an analysis of the location of a speech sound feature within the speech sound in time and frequency, or any other combination of dimensions. In some embodiments, each dimension may be associated with a particular modification made to the speech sound. For example, the location of a speech sound feature in time, frequency, and intensity may be determined in part by applying various truncation, filters, and white noise, respectively, to the speech sound. In some embodiments, the multi-dimensional approach may be applied to natural speech or natural speech recordings to isolate and identify the features related to a particular speech sound. For example, speech may be modified by adding noise of variable degrees, truncating a section of the recorded speech from the onset, performing high- and/or low-pass filtering of the speech using variable cutoff frequencies, or combinations thereof. For each modification of the speech, the identification of the sound by a large panel of listeners may be measured, and the results interpreted to determine where in time, frequency and at what signal to noise ratio (SNR) the speech sound has been masked, i.e., to what degree the changes affect the speech sound. Thus, embodiments of the invention allow for “triangulation” of the location of the speech sound features and the events, along the several dimensions.

According to a multi-dimensional approach, a speech sound may be characterized by multiple properties, including time, frequency and intensity. Event identification involves isolating the speech cues along the three dimensions. Prior work has used confusion tests of nonsense syllables to explore speech features. However, it has remained unclear how many speech cues could be extracted from real speech by these methods; in fact there is high skepticism within the speech research community as the general utility of such methods. In contrast, embodiments of the invention make use of multiple tests to identify and analyze sound features from natural speech. According to embodiments of the invention, to evaluate the acoustic cues along three dimensions, speech sounds are truncated in time, high/lowpass filtered, or masked with white noise and then presented to normal hearing (NH) listeners.

One method for determining the influence of an acoustic cue on perception of a speech sound is to analyze the effect of removing or masking the cue on the speech sound, to determine whether it is degraded and/or the recognition score of the is sound significantly altered. This type of analysis has been performed for the sound /t/, as described in “A method to identify noise-robust perceptual features: application for consonant /t/,” J. Acoust. Soc. Am. 123(5), 2801-2814, and U.S. application Ser. No. 11/857,137, filed Sep. 18, 2007, the disclosure of each of which is incorporated by reference in its entirety. As described therein, it has been found that the /t/ event is due to an approximately 20 ms burst of energy, between 4-8 kHz. However, this method is not readily expandable to many other sounds.

Methods involved in analyzing speech sounds according to embodiments of the invention will now be described. Because multiple dimensions, most commonly three dimensions, may be used, techniques according to embodiments of the invention may be referred to as “multi-dimensional” or “three-dimensional (3D)” approaches, or as a “3D deep search.”

To estimate the importance of individual speech perception events for sounds in addition to /t/, embodiments of the invention utilize multiple independent experiments for each consonant-vowel (CV) utterance. The first experiment determines the contribution of various time intervals, by truncating the consonant. Various time ranges may be used, for example multiple segments of 5, 10 or 20 ms per frame may be used, depending on the sound and its duration. The second experiment divides the fullband into multiple bands of equal length along the BM, and measures the score in different frequency bands, by using highpass- and/or lowpass-filtered speech as the stimuli. Based on the time-frequency coordinate of the event as identified in the previous experiments, a third experiment may be used to assess the strength of the speech event by masking the speech at various signal-to-noise ratios. To reduce the length of the experiments, it may be presumed that the three dimensions, i.e., time, frequency and intensity, are independent. The identified events also may be verified by software designed for the manipulation of acoustic cues, based on the short-time Fourier transform.

According to embodiments of the invention, after a speech sound has been analyzed to determine the effects of one or more features on the speech sound, spoken speech may be modified to improve the intelligibility or recognizability of the speech sound for a listener. For example, the spoken speech may be modified to increase or reduce the contribution of one or more features or other portions of the speech sound, thereby enhancing the speech sound. Such enhancements may be made using a variety of devices and arrangements, as will be discussed in further detail below.

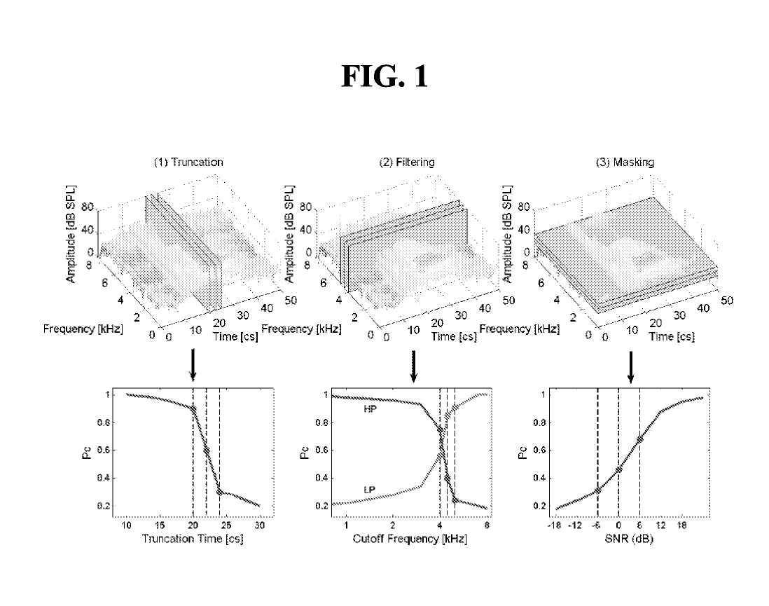

FIG. 1 shows an example application of a 3D approach to identify acoustic cues according to an embodiment of the invention. To isolate the cue along the time, a speech sound may be truncated in time from the onset with various step sizes, such as 5, 10, and/or 20 ms, depending on the duration and type of consonant. To locate the cue along the frequency axis, a speech sound may be highpass and lowpass filtered before being presented to normal hearing listeners. To measure the strength of the cue, a speech sound may be masked by white noise of various signal-to-noise ratio (SNR). In the example shown in FIG. 1, the three plots on the top row illustrate how the speech sound is processed in each dimension. Typical correspondent recognition scores (Pc) are depicted in the plots on the bottom row. It will be understood that the specific waveforms and results shown in FIG. 1 are provided by way of example only, and embodiments of the invention may be applied in different combinations and to different sounds than shown.

In an embodiment, separate experiments or sound analysis procedures may be performed to analyze speech according to the three dimensions described with respect to FIG. 1: time-truncation (TR07), high/lowpass filtering (HL07) and “Miller-Nicely (2005)” noise masking (MN05).

TR07 evaluates the temporal property of the events. Truncation starts from the beginning of the utterance and stops at the end of the consonant. In an embodiment, truncation times may be manually chosen, for example so that the duration of the consonant is divided into non-overlapping consecutive intervals of 5, 10, or 20 ms. Other time frames may be used. An adaptive scheme may be applied to calculate the sample points, which may allow for more points to be assigned in cases where the speech changes rapidly, and fewer points where the speech is in a steady condition. In the example process performed, eight frames of 5 ms were allocated, followed by twelve frames of 10 ms, and as many 20 ms frames starting from the end of the consonant near the consonant-vowel transition, as needed, until the entire interval of the consonant was covered. To make the truncated speech sounds more natural, and to remove an possible onset truncation artifacts, white noise also may be applied to mask the speech stimuli, for example at an SNR of 12 dB.

HL07 allows for analysis of frequency properties of the sound events. A variety of filtering conditions may be used. For example, in one experimental process performed according to an embodiment of the invention, nineteen filtering conditions, including one full-band (250-8000 Hz), nine highpass and nine lowpass conditions were included. The cutoff frequencies were calculated using Greenwood function, so that the full-band frequency range was divided into 12 bands, each having an equal length along the basilar membrane. The highpass cutoff frequencies were 6185, 4775, 3678, 2826, 2164, 1649, 1250, 939, and 697 Hz, with an upper-limit of 8000 Hz. The lowpass cutoff frequencies were 3678, 2826, 2164, 1649, 1250, 939, 697, 509, and 363 Hz, with the lower-limit being fixed at 250 Hz. The highpass and lowpass filtering used the same cutoff frequencies over the middle range. As with TR07, white noise may be added, for example at a 12 dB SNR, to make the modified speech sounds more natural sounding.

MN05 assesses the strength of the event in terms of noise robust speech cues, under adverse conditions of high noise. In the performed experiment, besides the quiet condition, speech sounds were masked at eight different SNRs: −21, −18, −15, −12, −6, 0, 6, 12 dB, using white noise. Further details regarding the specific MN05 experiment as applied herein are provided in S. Phatak and J. B. Allen, J. B. “Consonant and vowel confusions in speech-weighted noise,” J. Acoust. Soc. Am. 121(4), 2312-26 (2007), the disclosure of which is incorporated by reference in its entirety.

Various procedures may be applied to implement the analysis tools (“experiments”) described above. A specific example of such procedures is described in further detail below. It will be understood that these procedures may be modified without departing from the scope of the invention, as will be readily understood by one of skill in the art.

In some embodiments, an AI-gram as known in the art may be used to analyze and illustrate understand how speech sounds are represented on the basilar membrane. This construction is a what-you-see-is-what-you-hear (WISIWYH) signal processing auditory model tool, to visualize audible speech components. The AI-gram estimates the speech audibility via Fletcher's Articulation Index (AI) model of speech perception. The AI-gram tool crudely simulates audibility using an auditory peripheral processing (a linear Fletcher-like critical band filter-bank). Further details regarding the construction of an AI-gram and use of the AI-gram tool are provided in M. S. Regnier et al., “A method to identify noise-robust perceptual features: application for consonant /t/,” J. Acoust. Soc. Am. 123(5), 2801-2814 (2008), the disclosure of which is incorporated by reference in its entirety. A brief summary of the AI-gram is also provided below.

The results of TR07, HL07 and MN05 take the form of confusion patterns (CPs), which display the probabilities of all possible responses (the target and competing sounds), as a function of the experimental conditions, i.e., truncation time, cutoff frequency and signal-to-noise ratio. As used herein, c_{x|y} denotes the probability of hearing consonant /x/ given consonant /y/. When the speech is truncated to time tₙ the score is denoted c_{x|y}^{T}(tₙ). The score of the lowpass and highpass experiment at cutoff frequency fₖ is indicated as c_{x|y}^{L/H}(fₖₙ). Finally the score of the masking experiment as a function of signal-to-noise ratio is denoted c_{x|y}^{M}(SNRₖ).

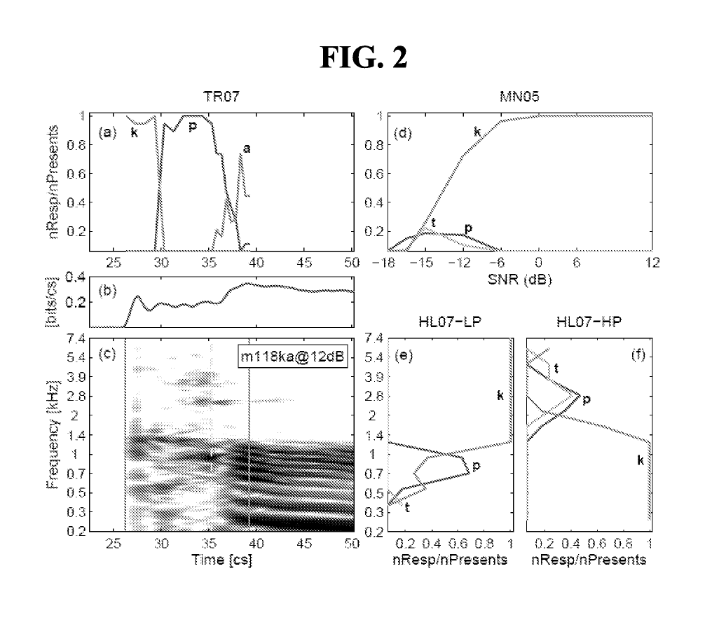

A specific example of a 3D method according to an embodiment of the invention will now be described, which shows how speech perception may be affected by events. FIG. 2 depicts the CPs of /ka/ produced by an individual talker “m118” (using utterance “m118 ka”). The TR07 time truncation results are shown in panel (a), HL07 low- and highpass as functions of cutoff frequency in panels (e) and (f), respectively, and CP as a function of SNR as observed in MN05 in panel (d). The instantaneous AI aₙ≡a(tₙ) at truncation time tₙ is shown in panel (b), and the AI-gram at 12 dB SNR in panel (c). To facilitate the integration of the three experiments, the AIgram and the three scores are aligned in time (tₙ in centiseconds (cs)) and frequency (along the cochlear place axis, but labeled in frequency), and thus depicted in a compact manner.

The CP of TR07 shows that the probability of hearing /ka/ is 100% for tₙ<26 cs, when little or no speech component has been removed. However, at around 29 cs, when the /ka/ burst has been almost completely or completely truncated, the score for /ka/ drops to 0% within a span of 1 cs. At this time (about 32-35 cs) only the transition region is heard, and 100% of the listeners report hearing a /pa/. After the transition region is truncated, listeners report hearing only the vowel /a/.

As shown in panels (e) and (f), a related conversion occurs in the lowpass and highpass experiment HL07 for /ka/, in which both the lowpass score c_{k|k}^{L} and highpass score c_{k|k}^{H} drop from 100% to less than about 10% at a cutoff frequency fₖ of about 1.4 kHz. In an embodiment, this frequency may be taken as the frequency location of the /ka/ cue. For the lowpass case, listeners reported a morphing from /ka/ to /pa/ with score c_{p|k}^{L} reaching about 70% at about 0.7 kHz. For the highpass case, listeners reported a morphing of /ka/ to /ta/ at the c_{t|k}^{H}=0.4 (40%) level. The remaining confusion patterns are omitted for clarity.

As shown in panel (d), the MN05 masking data indicates a related confusion pattern. When the noise level increases from quiet to 0 dB SNR, the recognition score of /ka/ is about 1 (i.e., 100%), which usually signifies the presence of a robust event.

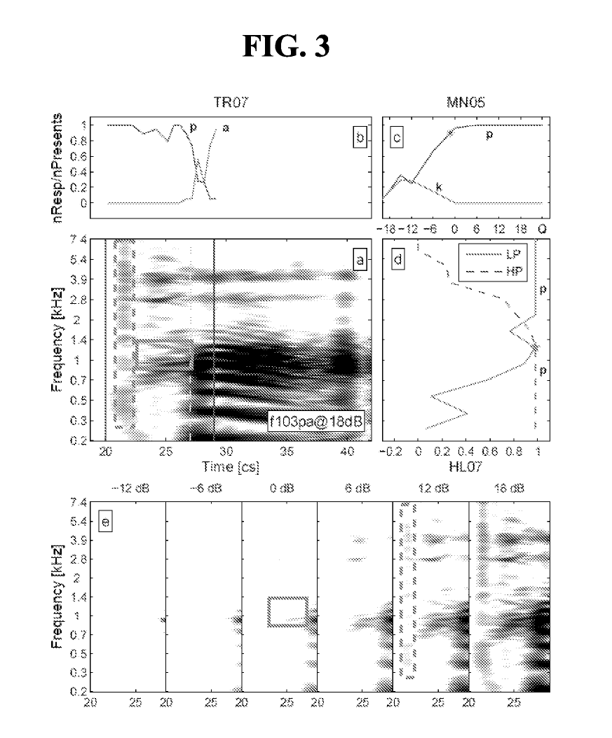

An example of identifying stop consonants by applying a 3D approach according to an embodiment of the invention will now be described. For convenience, the results from the three analysis procedures are arranged in a compact form as previously described. Referring to FIG. 3, for example, panel (a) shows the AI-gram of the speech sound at 18 dB SNR, upon which each event hypothesis is highlighted by a rectangular box. The middle vertical dashed line denotes the voice-onset time, while the two vertical solid lines on either side of the dashed line denote the starting and ending points for the TR07 time truncation process. Panel (b) shows the scores from TR07. Panel (d) shows the scores from HL07. Panel (c) shows the scores from experiment MN05. The CP functions are plotted as solid (lowpass) or dashed (highpass) curves, with competing sound scores with a single letter identifier next to each curve. The * in panel (c) indicates the SNR where the listeners begin to confuse the sound in MN05. The star in panel (d) indicates the intersection point of the highpass and lowpass scores measured in HL07. The six figures in panel (e) show partial AI-grams of the consonant region, delimited in panel (a) by the solid lines, at −12, −6, 0, 6, 12, 18 dB SNR. A box in any of the seven AI grams of panels (a) or (e) indicates a hypothetical event region, and for (e), indicates its visual threshold according to the AI-gram model. Similar results and analysis are presented for other sounds in further detail below, including the unvoiced stops/p/, /t/ and /k/, followed by vowel /a/ as in “father.” For each consonant, six utterances were analyzed, discussed by the research group, and a representative example is presented.

FIG. 3 shows hypothetical events for /pa/ from talker f103 according to an embodiment of the invention. Panel (a) shows the AI-gram with a dashed vertical line showing the onset of voicing (sonorance), indicating the start of the vowel. The solid boxes indicate hypothetical sources of events. Panel (b) shows confusion patterns as a function of truncation time tₙ. Panel (c) shows the CPs as a function of SNRₖ. Panel (d) shows CPs as a function of cutoff frequency fₖ. Panel (e) shows AI-grams of the consonant region defined by the solid vertical lines in panel (a), at −12, −6, 0, 6, 12, and 18 dB SNR. The wide band click becomes barely intelligible when the SNR is less than 12 dB. The F₂ transition remains audible at 0 dB SNR. The analysis illustrated in FIG. 3 for indicates that there may be two different events: 1) a formant transition at 1-1.4 kHz, which appears to be the dominant cue, maskable by white noise at 0 dB SNR; and 2) a wide band click running from 0.3-7.4 kHz, maskable by white noise at 12 dB SNR. Stop consonant /pa/ is traditionally characterized as having a wide band click which is seen in this /pa/ example, but not in five others studied. For most /pa/s, the wide band click diminishes into a low-frequency burst. The click does appear to contribute to the overall quality of /pa/ when it is present.

Time Analysis: Referring to panel (b), the truncated /p/ score c_{p|p}^{T}(tₙ) according to an embodiment is illustrated. The score begins at 100% but, begins to decrease slightly when the wide band click, which includes the low-frequency burst, is truncated at around 23 cs. The score drops to the chance level (1=16) only when the transition is removed at 27 cs. At this time subjects begin to report hearing the vowel /a/ alone. Thus, even though the wide band click contributes slightly to the perception of /pa/, the F₂ transition appears to play the main role.

Frequency Analysis: The lowpass and highpass scores, as depicted in panel (d) of FIG. 3, start at 100% at each end of the spectrum, and begin to drop near the intersection point, close to 1.3 kHz. This intersection (indicated by a star) appears to be a clear indicator of the center frequency of the dominant perceptual cue, which is the F₂ region running from 22 cs to 26 cs, as labeled by the truncation data in panel (b).

Amplitude analysis: Panel (c) of FIG. 3 shows the recognition score c_{p|p}^{M} as a function of SNR. The score drops to 90% at 0 dB SNR (SNR₉₀ denoted by *), at the same time the /pa/→/ka/ confusion c_{p|k}^{M} begins to increase. The six AI-grams of panel (e) show that the audible threshold for the F₂ transition is at 0 dB SNR, the same as the SNR₉₀ point in panel (c) where the listeners begin to lose the sound, giving credence to the energy of F₂ sticking out in front of the sonorant portion of the vowel, as the main cue for /pa/ event.

The 3D displays of other five /pa/s (not shown) are in basic agreement with that of FIG. 3, with the main difference being the existence of the wideband burst at 22 cs for f103, and slightly different highpass and lowpass intersection frequency, ranging from 0.7-1.4 kHz, for the other five sounds. The required duration of the F₂ energy before the onset of voicing was seen around 3-5 cs before the onset of voicing and this timing too, is very critical to the perception of /pa/. The existence of excitation of F₃ is evident in the AI-grams, but it does not appear to interfere with the identification of /pa/, unless F₂ has been removed by filtering (a minor effect for f103). Also /ta/ was identified in a few examples, as high as 40% when F₂ was masked.

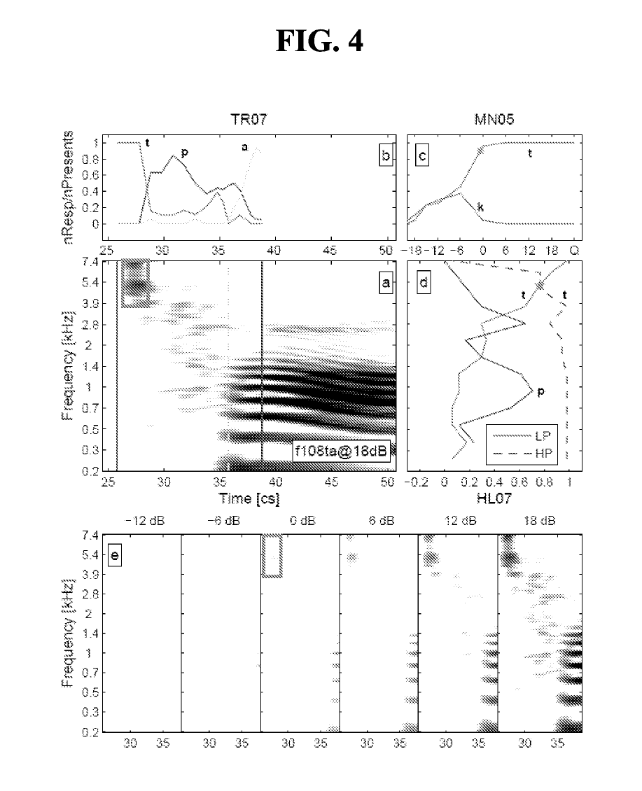

FIG. 4 shows analysis of /ta/ from talker f105 according to an embodiment of the invention. Panel (a) shows the AI-gram with identified events highlighted by a rectangular box. Panels (b), (c), and (d) show CPs for the TR07, HL07 and MN05 procedures. Panel (e) shows AI-grams of the consonant part at −12, −6, 0, 6, 12, 18 dB SNR, respectively. The event becomes masked at 0 dB SNR. From FIG. 4, it can be seen that the /ta/ event for talker f105 is a short high-frequency burst above 4 kHz, 1.5 cs in duration and 5-7 cs prior to the vowel.

Time Analysis: In panel (b), the score for the truncated /t/ drops at 28 cs and remains at chance level for later truncations, suggesting that the high-frequency burst is critical for /ta/ perception. At around 29 cs when the burst has been completely truncated and the listeners can only listen to the transition region, listeners start reporting a /pa/. By 32 cs, the /pa/ score climbs to 85%. These results agree with the results of /pa/ events as previously described. Once the transition region is also truncated, as shown by the dashed line at 36 cs in panel (a), subjects report only hearing the vowel, with the transition from 50%/pa/→/a/occurring at about 37 cs.

Frequency Analysis: In panel (d), the intersection of the highpass and the lowpass perceptual scores (indicated by the star) is at around 5 kHz, showing the dominant cue to be the high-frequency burst. The lowpass CPs (solid curve) show that once the high frequency burst is removed, the /ta/ score c_{t|t}^{L} drops dramatically. The off-diagonal lowpass CP data c_{p|t}^{L} (solid curve labeled “p” at 1 kHz) indicates that confusion with /pa/ is very high once all the high frequency information is removed. This can be explained by reference to the results illustrated in FIG. 3, which show the significance of the F₂ transition around 1 kHz for /pa/ identification. Given only low-frequency bands, while /ta/ cannot be perceived, it can be guessed (chance typically plays a relatively important role when the set size is small). The best alternative in such cases seems to be a low frequency /pa/, as found from the previous results shown in FIG. 3. The highpass results agree with the view that /ta/ results from the high-frequency burst.

Amplitude Analysis: The /ta/ burst has an audible threshold of −1 dB SNR in white noise, defined as the SNR where the score drops to 90%, namely SNR₉₀ [labeled by a * in panel (c)]. When the /ta/ burst is masked at −6 dB SNR, subjects report /ka/ and /ta/ equally, with a reduced score around 30%. The AI-grams shown in panel (e) show that the high-frequency burst is lost between 0 dB and −6 dB, consistent with the results of FIG. 4 panel (c) that SNR₉₀=−1 dB SNR.

Based on this analysis, the event of /ta/ is verified to be a high-frequency burst above 4 kHz. The perception of /ta/ is dependent on the identified event which explains the sharp drop in scores when the high-frequency burst is masked. These results are therefore in complete agreement with the earlier, single-dimensional analysis of /t/ by Regnier and Allen (2008), as well as many of the conclusions from the 1950s Haskins Laboratories research.

Of the six /ta/ sounds, five morphed to /pa/ once the /ta/ burst was truncated (e.g., FIG. 4, panel (b)), while one morphed to /ka/ (m112ta), with a relatively high 90% score. This same sound also became /ka/ rather than /pa/ following lowpass filtering below 2.8 kHz, with a 100% score. For this particular sound, it is seen that the /ta/ burst precedes the vowel only by around 2 cs, instead of the 5-7 cs which is the case for a normally articulated /ta/. This timing cue is especially important for the perception of /pa/ since the transition region and relative timing of this transition region is critical to /pa/ perception.

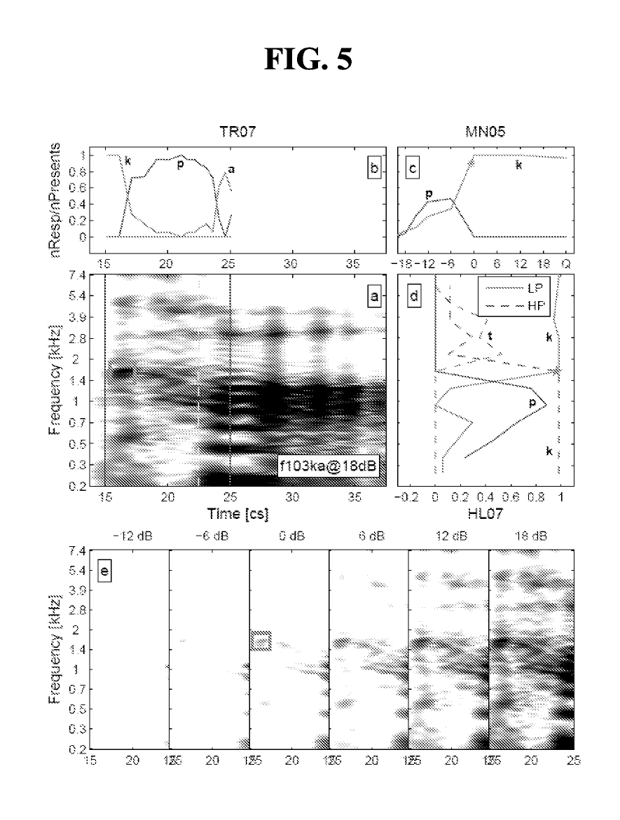

FIG. 5 shows an example analysis of /ka/ from talker f103 according to an embodiment of the invention. Panel (a) shows the AI-gram with identified events highlighted by rectangular boxes. Panels (b), (c), and (d) show the CPs for TR07, HL07 and MN05, respectively. Panel (e) shows AI-grams of the consonant part at −12, −6, 0, 6, 12, 18 dB SNR. The event remains audible at 0 dB SNR. As described in further detail below, analysis of FIG. 5 reveals that the event of /ka/ is a mid-frequency burst around 1.6 kHz, articulated 5-7 cs before the vowel, as highlighted by the rectangular boxes in panels (a) and (e).

Time Analysis: Panel (b) shows that once the mid-frequency burst is truncated at 16.5 cs, the recognition score c_{k|k}^{T} rises from 100% to chance level within 1-2 cs. At the same time, most listeners begin to hear /pa/ with the score (c_{p|k}^{T}) rises to 100% at 22 cs, which agrees with other conclusions about the /pa/ feature as previously described. As seen in panel (a), there may be high-frequency (e.g., 3-8 kHz) bursts of energy, but usually not of sufficient amplitude to trigger /t/ responses. Since these /ta/-like bursts occur around the same time as the mid-frequency /ka/ feature, time truncation of the /ka/ burst results in the simultaneous truncation of these potential /t/ cues. Thus truncation beyond 16.5 cs result in confusions with /p/, not /t/. Beyond 24 cs, subjects report only the vowel.

Frequency Analysis: As illustrated by panel (d) the highpass score c_{k|k}^{H} and the lowpass score c_{k|k}^{L} cross at 1.4 kHz. Both curves have a sharp decrease around the intersection point, suggesting that the perception of /ka/ is dominated by the mid-frequency burst as highlighted in panel (a). The highpass c_{t|k}^{H}, shown by the dashed curve of panel (d), indicates minor confusions with /ta/ (e.g., 40%) for f_{c}>2 kHz. This is in agreement with the conclusion about the /ta/ feature being a high-frequency burst. Similarly, the lowpass CP around 1 kHz shows strong confusions with /pa/ (c_{p|k}^{L}=90%), when the /ka/ burst is absent.

Amplitude Analysis: From the AI-grams shown in panel (e), the burst is identified as being just above its detection threshold at 0 dB SNR. Accordingly, the recognition score of /ka/ c_{k|k}^{M} in panel (c) drops rapidly at 0 dB SNR. At −6 dB SNR the burst has been fully masked, with most listeners reporting /pa/ instead of /ka/.

Not all of the six sounds strongly morphed to /pa/ once the /ka/ burst was truncated, as is seen in FIGS. 2(a) and 5(b). Two out of six had no morphs, just remained a very weak /ka/ once the onset-burst was removed (m114ka, f119ka). These scores are consistent with guessing. It has been found that, when the burst of /ka/ or /ta/ is masked or removed, the auditory system can pick up residual transitions in the low-frequency, which would cause the sound to morph to /pa/. In speech perception tests, /pa, ta, ka/ commonly form a confusion group. This can be explained by the fact that the three sounds share the same type of event patterns, i.e., burst and F₂ transition. The relative timing for these three unvoiced sounds is nearly the same, with a major difference being in the center frequencies of the bursts, with the /pa/ cue in the low-frequency, /ka/ in the mid-frequency, and /ta/ in the high-frequency.

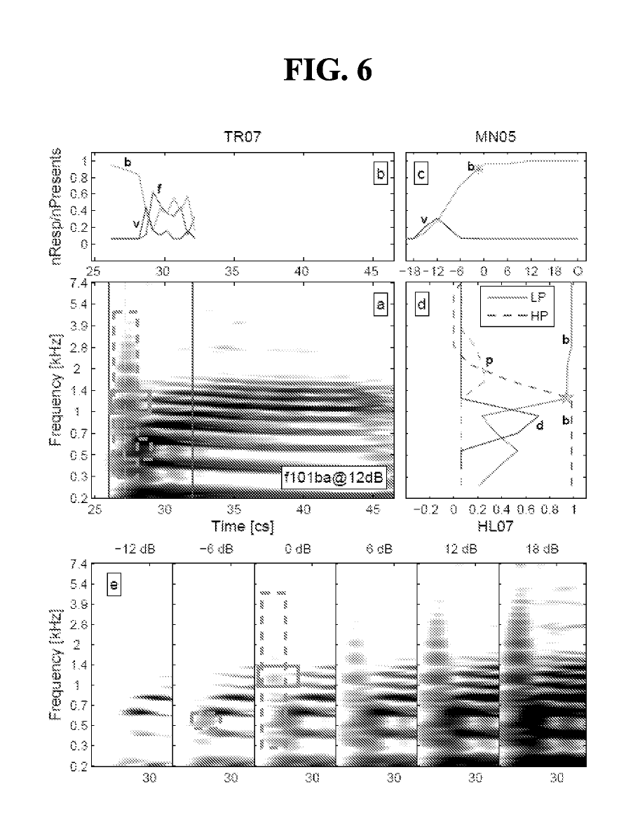

FIG. 6. shows an example analysis of /ba/ from talker f101 according to an embodiment of the invention. Panel (a) shows the AI-gram with identified events highlighted by rectangular boxes. Panels (b), (c), and (d) show CPs of TR07, HL07 and MN05, respectively. Panel (e) shows the AI-grams of the consonant part at −12, −6, 0, 6, 12, 18 dB SNR. The F₂ transition and wide band click become masked around 0 dB SNR, while the low-frequency burst remains audible at −6 dB SNR.

In some embodiments, the 3D method described herein may have a greater likelihood of success for sounds having high scores in quiet. Among the six /ba/ sounds used from the corpus, only the one illustrated in FIG. 6 (f111) had 100% scores at 12 dB SNR and above; thus, the /ba/ sound may be expected to be the most difficult and/or least accurate sound when analyzed using the 3D method. Based on the analysis of FIG. 6, it has been found that hypothetical features for /ba/ include: 1) a wide band click in the range of 0.3 kHz to 4.5 kHz; 2) a low-frequency around 0.4 kHz; and 3) a F₂ transition around 1.2 kHz.

Time Analysis: When the wide band click is completely truncated at tₙ=28 cs, the /ba/ score c_{b|b}^{T} as shown in panel (b) drops from 80% to chance level, at the same time the /ba/→/va/ confusion c_{v|b}^{T} for and /ba/→/fa/ confusion c_{f|b}^{T} increase relatively quickly, indicating that the wide band click is important for the distinguish of /ba/ from the two fricatives /va/ and /fa/. However, since the three events overlap on time axis, it may not be immediately apparent which event plays the major role.

Frequency Analysis: Panel (d) shows that the highpass score c_{b|b}^{H} and lowpass score c_{t|t}^{L} cross at 1.3 kHz, and both change fast within 1-2 kHz. According to an embodiment, this may indicate that the F₂ transition, centered around 1.3 kHz, is relatively important. Without the F₂ transition, most listeners guess /da/ instead of /ba/, as illustrated by the lowpass data for f_{c}<1 kHz. In addition, the small jump in the lowpass score c_{b|b}^{L} around 0.4 kHz suggests that the low-frequency burst may also play a role in /ba/ perception.

Amplitude Analysis: From the AI-grams in panel (e), it can bee seen that the F₂ transition and wide band click become masked by the noise somewhere below 0 dB SNR. Accordingly the listeners begin to have trouble identifying the /ba/ sound in the masking experiment around the same SNR, as represented by SNR₉₀ (*) in panel (c). When the wideband click is masked, the confusions with /va/ increase, and become equal to /ba/ at −12 dB SNR with a score of 40%.

There are the only three LDC /ba/ sounds out of 18 with 100% scores at and above 12 dB SNR, i.e., /ba/ from f101/ shown here and /ba/ from f109, which has a 20% /va/ error rate for SNR·−10 dB SNR. The remaining 18 /ba/ utterances have /va/ confusions between 5 and 20%, in quiet. The recordings in the LDC database may be responsible for these low scores, or the /ba/ may be inherently difficult. Low quality consonants with error rates greater than 20% were also observed in an LDC study described in S. Phatak and J. B. Allen, “Consonant and vowel confusions in speech-weighted noise,” J. Acoust. Soc. Am. 121(4), 2312-26 (2007). In some embodiments these low starting (quiet) scores may present particular difficulty in identifying the /ba/ event with certainty. It is believed that a wide band burst which exists over a wide frequency range may allow for a relatively high quality, i.e., more readily-distinguishable, /ba/ sound. For example, a well defined 3 cs burst from 0.3-8 kHz may provide a relatively strong percept of /ba/, which may likely be heard as /va/ or /fa/ if the burst is removed.

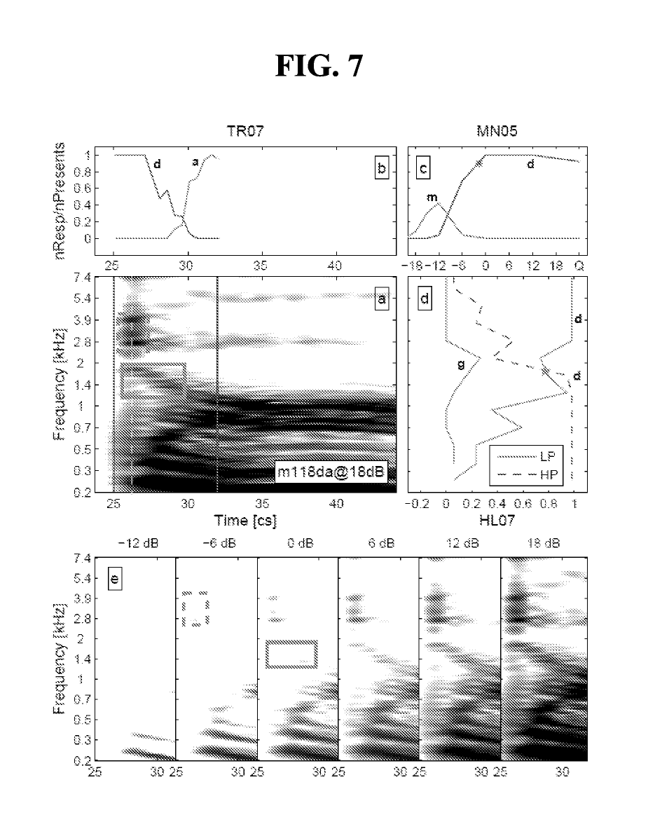

FIG. 7. shows an example analysis of /da/ from talker m118 according to an embodiment of the invention. Panel (a) shows the AI-gram with identified events highlighted by rectangular boxes. Panels (b), (c), and (d) show CPs of TR07, HL07 and MN05, respectively. Panel (e) shows AI-grams of the consonant part at −12, −6, 0, 6, 12, 18 dB SNR. The F₂ transition and the high-frequency burst remain audible at 0 and −6 dB SNR, respectively. Consonant /da/ is the voiced counterpart of /ta/. It has been found to be characterized by a high-frequency burst above 4 kHz and a F₂ transition near 1.5 kHz, as shown in panels (a) and (e).

Time Analysis: As shown in panel (b), truncation of the high-frequency burst leads to a drop in the score of c_{d|d}^{T} from 100% at 27 cs to about 70% at 27.5 cs. The recognition score continues to decrease until the F₂ transition is removed completely at 30 cs, at which point the subjects report only hearing vowel /a/. The truncation data indicate that both the high-frequency burst and F2 transition are important for /da/ identification.

Frequency Analysis: The lowpass score c_{d|d}^{L} and highpass score c_{d|d}^{H} cross at 1.7 kHz. In general, it has been found that subjects need to hear both the F₂ transition and the high-frequency burst to get a full score of 100%, indicating that both events contribute to a high quality /da/. Lack of the burst usually leads to the /da/→/ga/ confusion, as shown by the lowpass confusion of c_{g|d}^{L}=30% at f_{c}=2 kHz, as shown by the solid curve labeled “g” in panel (d).

Amplitude Analysis: As illustrated by the AI-grams shown in panel (e), the F₂ transition becomes masked by noise at 0 dB SNR. Accordingly, the /da/ score c_{d|d}^{M} in panel (c) drops relatively quickly at the same SNR. When the remnant of the high-frequency burst is gone at −6 dB SNR, the /da/ score c_{d|d}^{M} decreases even faster, until c_{d|d}^{M}=c_{m|d}^{M} at −10 dB SNR, namely the /d/ and /m/ scores are equal.

Two other /da/ sounds (f103, f119) showed a dip where the lowpass score decreases abnormally as the cutoff frequency increases, similar to that seen for /da/ of m118 (i.e., 1.2-2.8 kHz). Two showed larger gaps between the lowpass score c_{d|d}^{L} and highpass score c_{d|d}^{H}. The sixth /da/ exhibited a very wide-band burst going down to 1.4 kHz. In this case the lowpass filter did not reduce the score until it reached this frequency. For this example the cutoff frequencies for the high and lowpass filtering were such that there was a clear crossover frequency having both scores at 100%, at 1.4 kHz. These results suggest that some of the /da/s are much more robust to noise than others. For example, the SNR₉₀, defined as the SNR where the listeners begin to lose the sound (Pc=0.90), is −6 dB for /da/-m104, and +12 dB for /da/-m111. The variability over the six utterances is notable, but consistent with the conclusion that both the burst and the F₂ transition need to be heard.

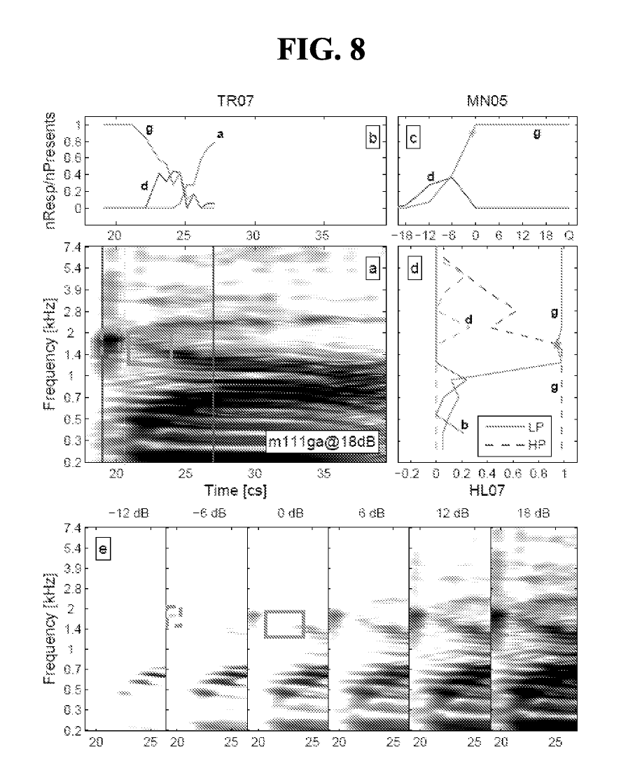

FIG. 8. shows an example analysis of /ga/ from talker m111 according to an embodiment of the invention. Panel (a) shows the AI-gram with identified events highlighted by rectangular boxes. Panels (b), (c), and (d) show the CPs of TR07, HL07 and MN05, respectively. Panel (e) shows AI-grams of the consonant part at −12, −6, 0, 6, 12, 18 dB SNR. The F₂ transition is barely intelligible at 0 dB SNR, while the mid-frequency burst remains audible at −6 dB SNR. The events of /ga/ include a mid-frequency burst from 1.4-2 kHz, followed by a F₂ transition between 1-2 kHz, as highlighted with boxes in panel (a).

Time Analysis: Referring to panel (b), the recognition score of /ga/ c_{g|g}^{T} starts to drop when the midfrequency burst is truncated beyond 22 cs. At the same time the /ga/→/da/ confusion appears, with c_{d|g}^{T}=40% at 23 cs. From 23-25 cs the probabilities of hearing /ba/ and /da/ are equal. This relatively low-grade confusion may be caused by similar F₂ transition patterns in the two sounds. Beyond 26 cs, where both events have been removed, subjects only hear the vowel /a/.

Frequency Analysis: Referring to panel (d), the highpass (dashed) score and lowpass (solid) score fully overlap at the frequency of 1.6 kHz, where both show a sharp decrease of more than 60%, which is consistent with /ga/ event results found in embodiments of the invention. There are minor /ba/ confusion c_{b|g}^{L}=20% at 0.8 kHz and /da/ confusion c_{d|g}^{H}=25% at 2 kHz. This may result from /ba/, /da/ and /ga/ all having the same or similar types of events, i.e., bursts and transitions, allowing for guessing within the confusion group given a burst onset coincident with voicing.

Amplitude Analysis: Based on the AI-grams in panel (e), the F₂ transition is masked by 0 dB SNR, corresponding to the turning point of c_{g|g}^{M} labeled by a * in panel (c). As the mid-frequency burst gets masked at −6 dB SNR, /ga/ becomes confused with /da/.

All six /ga/ sounds have well defined bursts between 1.4 and 2 kHz with well correlated event detection threshold as predicted by AI-grams in panel (e), versus SNR₉₀ [* in panel (c)], the turning point of recognition score where the listeners begin to lose the sound. Most of the /ga/s (m111, f119, m104, m112) have a perfect score of c_{g|g}^{M}=100% at 0 dB SNR. The other two /ga/s (f109, f108) are relatively weaker, their SNR₉₀ are close to 6 dB and 12 dB respectively.

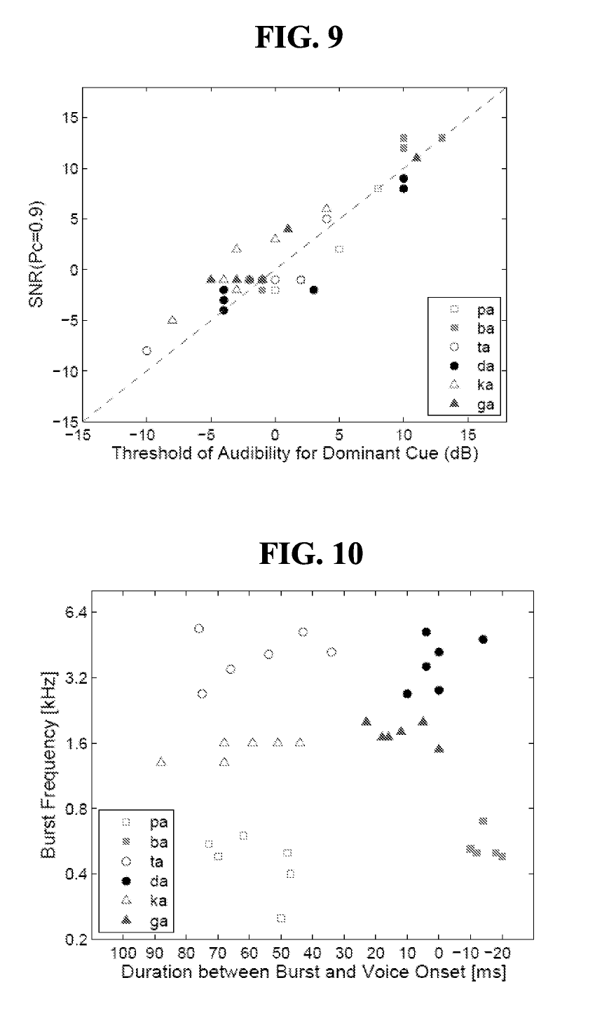

According to an embodiment of the invention, it has been found that the robustness of consonant sound may be determined mainly by the strength of the dominant cue. In the sound analysis presented herein, it is common to see that the recognition score of a speech sound remains unchanged as the masking noise increases from a low intensity, then drops within 6 dB when the noise reaches a certain level at which point the dominant cue becomes barely intelligible. In “A method to identify noise-robust perceptual features: application for consonant /t/,” J. Acoust. Soc. Am. 123(5), 2801-2814 (2008), M. S. Regnier and J. B. Allen reported that the threshold of speech perception with the probability of correctness being equal to 90% (SNR₉₀) is proportional to the threshold of the /t/ burst, using a Fletcher critical band measure (the AI-gram). Embodiments of the invention identify a related rule for the remaining five stop consonants. FIG. 9 depicts the scatter-plot of SNR₉₀ versus the threshold of audibility for the dominant cue according to embodiments of the invention. For a particular sound (each point on the plot), the SNR₉₀ is interpolated from the PI function, while the threshold of audibility for the dominant cue is estimated from the 36 AI-gram plots shown in panel (e) of FIGS. 4-8. The two thresholds show a relatively strong correlation, indicating that the recognition of each stop consonants is mainly dependent on the audibility of the dominant cues. Speech sounds with stronger cues are easier to hear in noise than weaker cues because it takes more noise to mask them. When the dominant cue (typically the burst) becomes masked by noise, the target sounds are easily confused with other consonants. In some cases it has been found that the masking of an individual cue is typically over about a 6 dB range, and not more, i.e., it appears to be an “all or nothing” detection task. Thus, embodiments of the invention suggest that it is the spread of the event threshold that is large, not the masking of a single cue.

A significant characteristic of natural speech is the large variability of the acoustic cues across the speakers. Typically this variability is characterized by using the spectrogram. Embodiments of the invention as applied in the analysis presented above indicate that key parameters are the timing of the stop burst, relative to the sonorant onset of the vowel (i.e., the center frequency of the burst peak and the time difference between the burst and voicing onset). These variables are depicted in FIG. 10 for the 36 utterances. The figure shows that the burst times and frequencies for stop consonants are well separated across the different talkers.

Based on the results achieved by applying an embodiment of the invention as previously described, it is possible to construct a description of acoustic features that define stop consonant events. A summary of each stop consonant will now be provided.

Unvoiced stop /pa/: As the lips abruptly release, they are used to excite primarily the F₂ formant relative to the others (e.g., F₃). This resonance is allowed to ring for approximately 5-20 cs before the onset of voicing (sonorance) with a typical value of 10 cs. For the vowel /a/, this resonance is between 0.7-1.4 kHz. A poor excitation of F₂ leads to a weak perception of /pa/. Truncation of the resonance does not totally destroy the /p/ event until it is very short in duration (e.g., not more than about 2 cs). A wideband burst is sometimes associated with the excitation of F₂, but is not necessarily audible to the listener or visible in the AI-grams. Of the six example /pa/ sounds, only f103 showed this wideband burst. When the wideband burst was truncated, the score dropped from 100% to just above 90%.

Unvoiced stop /ta/: The release of the tongue from its starting place behind the teeth mainly excites a short duration (1-2 cs) burst of energy at high frequencies (at least about 4 kHz). This burst typically is followed by the sonorance of the vowel about 5 cs later. The case of /ta/ has been studied by Regnier and Allen as previously described, and the results of the present study are in good agreement. All but one of the /ta/ examples morphed to /pa/, with that one morphing to /ka/, following low pass filtering below 2 kHz, with a maximum /pa/ morph of close to 100%, when the filter cutoff was near 1 kHz.

Unvoiced stop /ka/: The release for /k/ comes from the soft-pallet, but like /t/, is represented with a very short duration high energy burst near F₂, typically 10 cs before the onset of sonorance (vowel). In our six examples there is almost no variability in this duration. In many examples the F₂ resonance could be seen following the burst, but at reduced energy relative to the actual burst. In some of these cases, the frequency of F₂ could be seen to change following the initial burst. This seems to be a random variation and is believed to be relatively unimportant since several /ka/ examples showed no trace of F₂ excitation. Five of the six /ka/ sounds morphed into /pa/ when lowpass filtered to 1 kHz. The sixth morphed into /fa/, with a score around 80%.

Voiced stop /ba/: Only two of the six /ba/ sounds had score above 90% in quiet (f101 and f111). Based on the 3D analysis of these two /ba/ sounds performed according to an embodiment of the invention, it appears that the main source of the event is the wide band burst release itself rather than the F₂ formant excitation as in the case of /pa/. This burst can excite all the formants, but since the sonorance starts within a few cs, it seems difficult to separate the excitation due to the lip excitation and that due to the glottis. The four sounds with low scores had no visible onset burst, and all have scores below 90% in quiet. Consonant /ba-f111/ has 20% confusion with /va/ in quiet, and had only a weak burst, with a 90% score above 12 dB SNR. Consonant /ba-f101/ has a 100% score in quiet and is the only /b/ with a well developed burst, as shown in FIG. 6.

Voiced stop /da/: It has been found that the /da/ consonant shares many properties in common with /ta/ other than its onset timing since it comes on with the sonorance of the vowel. The range of the burst frequencies tends to be lower than with /ta/, and in one example (m104), the lower frequency went down to 1.4 kHz. The low burst frequency was used by the subjects in identifying /da/ in this one example, in the lowpass filtering experiment. However, in all cases the energy of the burst always included 4 kHz. The large range seems significant, going from 1.4-8 kHz. Thus, while release of air off the roof of the mouth may be used to excite the F₂ or F₃ formants to produce the burst, several examples showed a wide band burst seemingly unaffected by the formant frequencies.

Voiced stop /ga/: In the six examples described herein, the /ga/ consonant was defined by a burst that is compact in both frequency and time, and very well controlled in frequency, always being between 1.4-2 kHz. In 5 out of 6 cases, the burst is associated with both F₂ and F₃, which can clearly be seen to ring following the burst. Such resonance was not seen with /da/.

The previous discussion referred to application of embodiments of the invention to analyze consonant stops. In some embodiments, fricatives also may be analyzed using the 3D method. Generally, fricatives are sounds produced by an incoherent noise excitation of the vocal tract. This noise is generated by turbulent air flow at some point of constriction. For air flow through a constriction to produce turbulence, the Reynolds number must be at least about 1800. Since the Reynolds number is a function of air particle velocity, the density and viscosity of the air, and the smallest cross-sectional width of the construction, to generate a fricative a talker must position the tongue or lips to create a constriction width of about 2-3 mm and allow air pressure to build behind the constriction to create the necessary turbulence. Fricatives may be voiced, like the consonants /v, δ, z, ζ/ or unvoiced, like the consonants /f, θ, s, ∫/

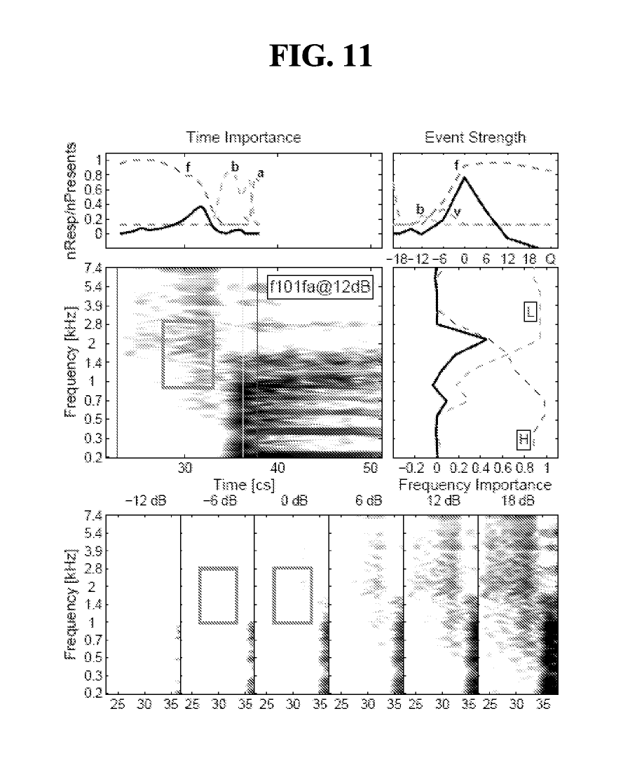

FIG. 11 shows an example analysis of the /fa/ sound according to an embodiment of the invention. The dominant perceptual cue is between 1 kHz to 2.8 kHz around 60 ms before the vocalic portion. The frequency importance function exhibits a peak around 2.4 kHz. For lowpass cutoff frequencies of greater than around 1.2 kHz, the score rises steadily. In the highpass experiment, cutoff frequencies lower 2.8 kHz lead to a steady increase in score and the score reaches relatively high values once the cutoff frequency is around 700 Hz. This suggests that the dominant cue is in the range of 1-2.8 kHz. The time importance function is seen to have a peak around 20 ms before the vowel articulation. The dominant cue may thus be isolated as shown in FIG. 11. To verify using the event strength function, one can see that the event strength function has a peak at 0 dB SNR. The AI grams show that the cue is considerably weakened if further noise is added, and the event strength function goes to chance at −6 dB.

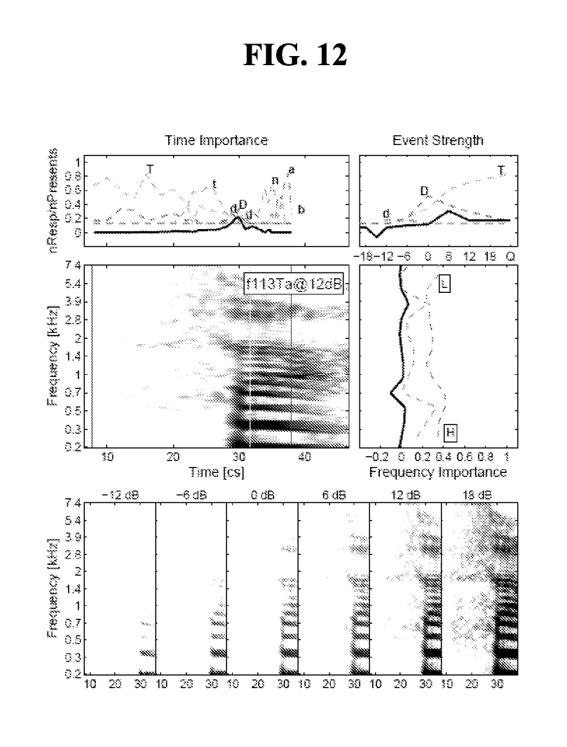

FIG. 12 shows an example analysis of the /θa/ sound according to an embodiment of the invention. As illustrated, the frequency importance function does not have a strong peak. The time importance function also has a relatively small peak at the onset of the consonant. For this speech sound, the score does not go much above 0.4 for any of the performed analysis. Moreover, even the event strength function remains very close to chance even at high SNR values. The confusion plots show that /θ/does not have a fixed confusion group; rather, it may be confused with a large number of other speech sounds and there with no fixed pattern for the confusions. Thus, it may be concluded that /θ/does not have a compact dominant cue.

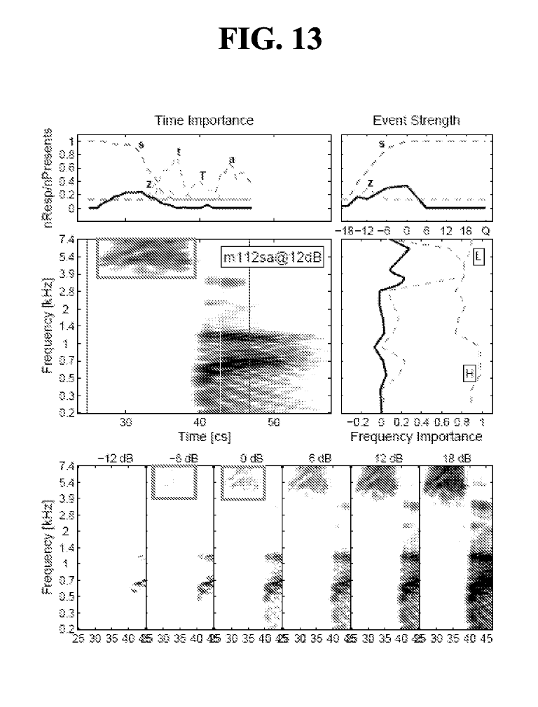

FIG. 13 shows an example analysis of the /sa/ sound according to an embodiment of the invention. The dominant perceptual cue of /sa/ is seen to be between 4 to 7.5 kHz and spans about 100 ms before the vowel is articulated. This cue is seen to be robust to white noise of around 0 dB SNR. The frequency importance function has two peaks close to each other in the range of about 3.9-7.4 kHz. The low pass experiment data indicate that after the cutoff frequency goes above around 3 kHz the score steadily rises to 0.9 at about 7.4 kHz. For the high pass filtering, there is a steady rise in score as the cutoff frequency goes below 7.4 kHz to almost 0.9 at about 4 kHz. In both cases, the change in score is relatively abrupt, which may signify that the feature is well defined in frequency. Referring to the truncation data, the time importance function is seen to have a peak around 100 ms before the vowel is articulated. The highlighted region thus may show the dominant perceptual cue for the consonant /s/. The event strength function also shows a peak at 0 dB, which may indicate that the strength of the cue begins decreasing at values of SNR below 0 dB. The AI-grams thus verify that the highlighted region likely is the perceptual cue.

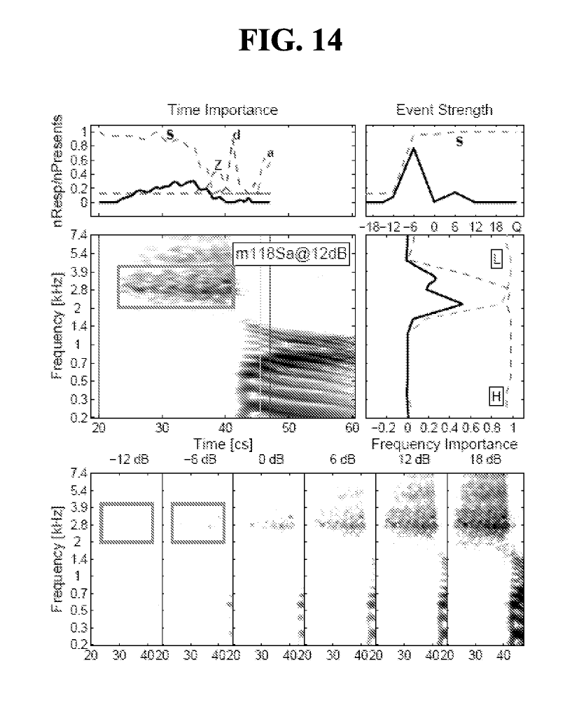

FIG. 14 shows an example analysis of the /∫a/ sound according to an embodiment of the invention. The dominant perceptual cue is between 2 kHz to 4 kHz, spanning around 100 ms before the vowel. The frequency importance function has a peak in the 2-4 kHz range. The low pass data increases as the low pass cutoff frequency goes above around 2 kHz. In the case of the high pass data, for cutoff frequencies above around 4 kHz, the score remains at chance levels. When the cutoff frequencies go below that level, the score increases significantly and reach their peak when the cutoff frequency goes below about 2 kHz. These results suggest that the /∫/ perceptual feature lies in the range of 2-4 kHz. The time importance function also shows a peak about 100 ms before the vowel is articulated. The event strength function verifies that the feature cue strength decreased for values of SNR less than about −6 dB, which is where the perceptual cue is weakened considerably as shown by the bottom panels of FIG. 14.

Among the above mentioned fricative speech sounds, the feature regions generally are found around and above 2 kHz, and span for a considerable duration before the vowel is articulated. In the case of /sa/ and /∫a/, the events of both sounds begin at about the same time, although the burst for /∫a/ is slightly lower in frequency than /sa/. This suggests that eliminating the burst at that frequency in the case of /∫/should give rise to the sound /s/. Although a distinct feature for /θ/may not be apparent, when masking is applied either of these four sounds, they are confused with each other. Masking by white noise, in particular, can cause these confusions, because the white noise may act as a low pass filter on sounds that have relatively high frequency cues, which may alter the cues of the masked sounds and result in confusions between /f/, /θ/, /s/, and /∫/.

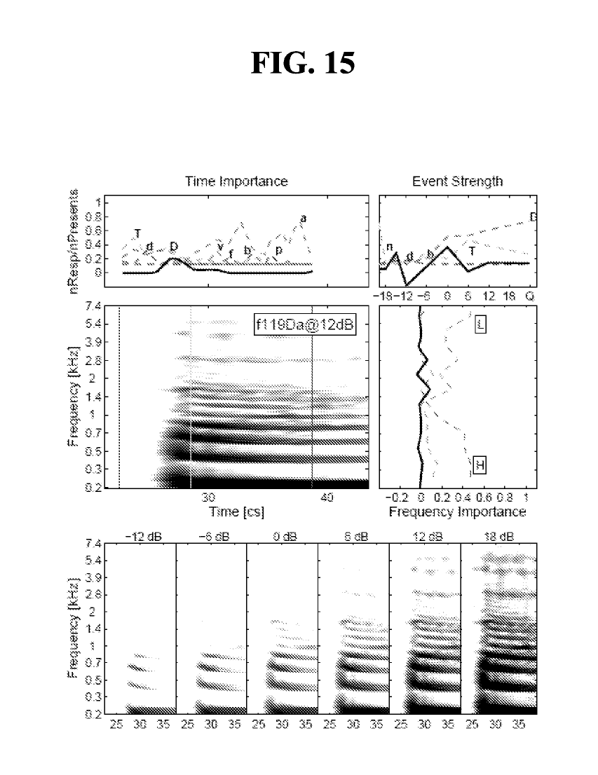

FIG. 15 shows an example analysis of the sound /δa/ according to an embodiment of the invention. Within the database of sounds, analyses according to embodiments of the invention indicate that seen that /θa/ and /θa/ have relatively low perception scores even at high SNRs. In the course of the highpass, lowpass, and truncation procedures, the highest scores for these two sounds are about 0.4-0.5 on average. These two sounds are characterized by a wide band noise burst at the onset of the consonant and, therefore, chances of confusions or alterations may be maximized in the case of these sounds. Thus, it may be difficult or require further processing or analysis to identify feature regions for /θ/and /δ/. As previously described with respect to /θ/, /δ/has a large number of confusions with several different sounds, indicating that it may not have a strong compact perceptual cue.

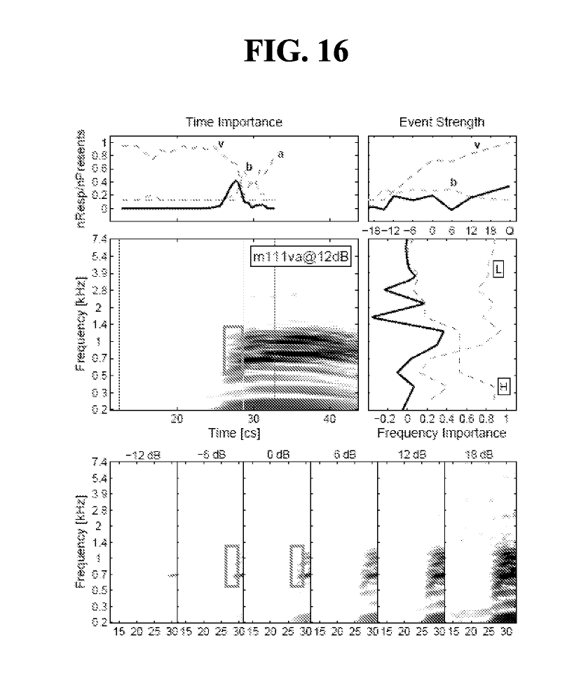

FIG. 16 shows an example analysis of the sound /va/ according to an embodiment of the invention. The /v/ feature is seen to be between about 0.5 kHz to 1.5 kHz, and most appears in the transition as highlighted in the mid-left panel of FIG. 15. The frequency importance function has a peak in the range of about 500 Hz to 1.5 kHz, and the time importance function also has a peak at the transition region as shown in the top-left panel. The frequency importance function also has a peak at around 2 kHz due to confusion with /ba/. The feature can be verified by looking at the event strength function which steadily drops from 18 dB SNR and touches chance performance at around −6 dB SNR. At −6 dB, the perceptual cue is almost removed and at this point the event strength function is very close to chance.

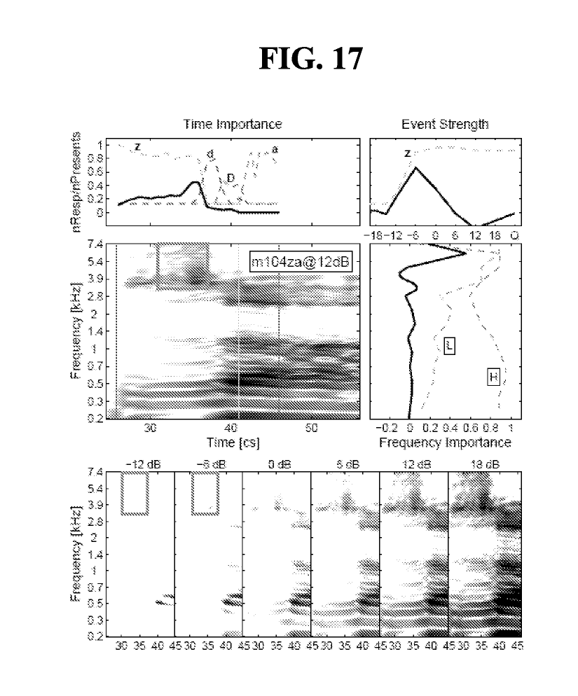

FIG. 17 shows an example analysis of /za/ according to an embodiment of the invention. The /za/ feature appears between about 3 kHz to 7.5 kHz and spans about 50-70 ms before the vowel is articulated as highlighted in the mid-left panel. This feature is seen to be robust to white noise of −6 dB SNR. The frequency importance function shows a clear peak at around 5.6 kHz. The low pass score rises after cutoff frequencies reach around 2.8 kHz. The high pass score is relatively constant after about 4 kHz. A brief decrease in the score indicates an interfering cue of /ζ/. The time importance function has a peak around 70 ms before the vowel is articulated as shown in the top-left panel. For verification, the event strength function decreases at about −6 dB which is also where the dominant perceptual cue is weaker.

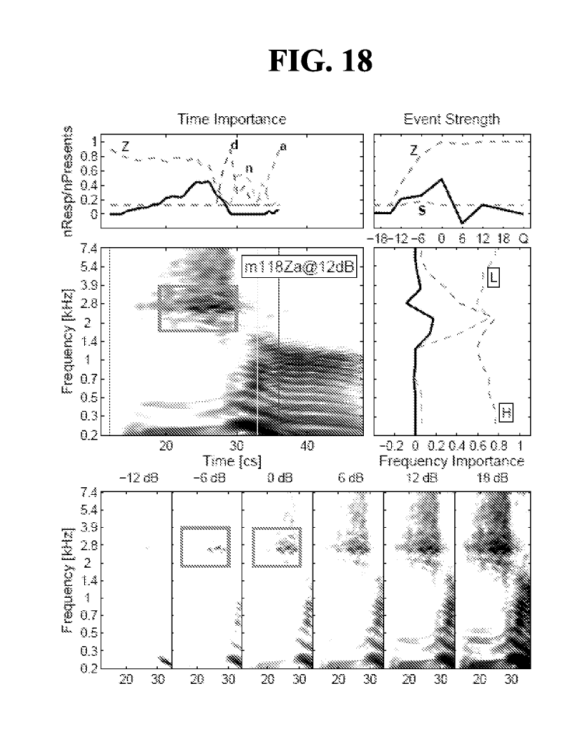

FIG. 18 shows an example analysis of /ζ/ according to an embodiment of the invention. The /ζa/ perceptual cue occurs between about 1.5 kHz to 4 kHz, spanning about 50-70 ms before the vowel is articulated. This cue is robust to white noise of 0 dB SNR. The frequency importance function has a peak at about 2 kHz. The low pass data increases after cutoff frequencies of around 1.2 kHz, showing that the perceptual cue is present in frequencies higher than 1.2 kHz. The high pass score reaches 1 after cutoff frequencies of about 1.4 kHz. The time importance function peaks around 50-70 ms before the vowel is articulated, which is where the perceptual cue is seen to be present. The event strength function confirms this result with a distinct peak at 0 dB, which is where the perceptual cue starts losing strength.

In the case of the voiced fricatives, it is noticed that /f/ and /0/are not prominent in the confusion group of /f/, /θ/, /s/, and /∫/, primarily as /f/ has stronger confusions with the voiced consonant /b/ and unvoiced fricative /v/ and /θ/has no consistent patterns as far as confusions with other consonants is concerned. Similarly for the unvoiced fricatives, /v/ and /δ/ are not prominent in the confusion group as /v/ is often confused with /b/, and /f/ and /δ/ show no consistent confusions.

Embodiments of the invention also may be applied to nasal sounds, i.e., those for which the nasal tract provides the main sound transmission channel. A complete closure is made toward the front of the vocal tract, either by the lips, by the tongue at the gum ridge or by tongue at the hard or soft palate and the velum is opened wide. As may be expected, most of the sound radiation takes place at the nostrils. The nasal consonants described herein include /m/ and /n/.

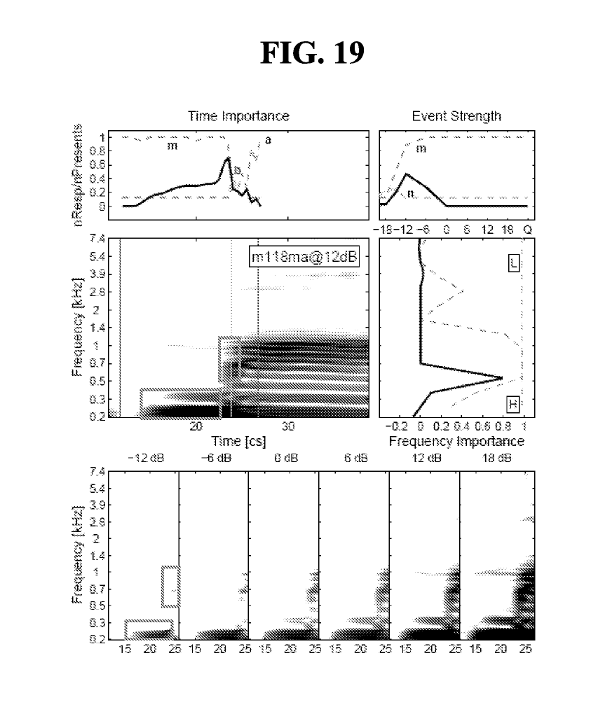

FIG. 19 shows an example analysis of the /ma/ sound according to an embodiment of the invention. The perceptual cues of /ma/ include the nasal murmur around 100 ms before the vowel is articulated and a transition region between about 500 Hz to 1.5 kHz as highlighted in the mid-left panel. The frequency importance function has a peak at around 0.6 kHz. The low pass score steadily increases as the cutoff frequency is increased above 0.3 kHz and by around 0.6 kHz, the score reaches 1. With the high pass experiment, a sudden decrease in score is seen at cutoff frequencies between about 1.4 kHz to 2 kHz. A further decrease in the cutoff frequency leads to increasing scores again which reach 1 at around 1 kHz. The time importance function also shows a peak at around the transition region of the consonant and the vowel. Thus, the highlighted region in the mid-left panel is the /ma/perceptual cue. It can be observed that the formant transition with regard to the second formant practically plays no role in perception for /ma/. Moreover, as there is a low frequency voice bar present in all voiced sounds which is a specific characteristic, a low frequency nasal murmur may be seen for the nasal sounds as well. This nasal murmur however, may not coincide with the onset of the consonant as in the case of the voice bar. On the other hand, it is seen to precede the onset of consonant.

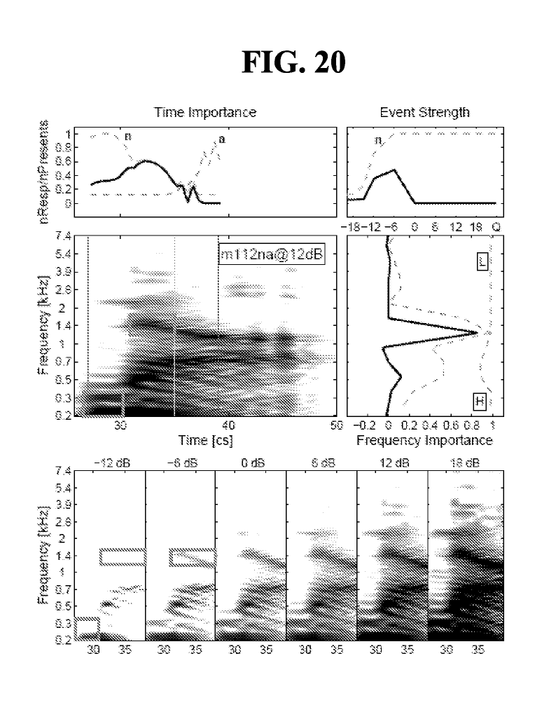

FIG. 20 shows an example analysis of the /na/ sound according to an embodiment of the invention. The perceptual cues include a low frequency nasal murmur about 80-100 ms before the vowel and a F₂ transition around 1.5 kHz. In the low pass filtering experiment, the score remains about at chance up to about 0.4 kHz, after which it steadily increases. An intermittent peak is seen in the score at about 0.5-1 kHz. In the high pass data, the scores reach a high score after about a 1.4 kHz cutoff frequency. Much like /m/, the time importance function for /n/ has a peak around the transition region. Combining this information with the truncation data, the feature can be narrowed down as highlighted. For the nasal /na/ the F₂ formant transitions are much more prominent. This feature may distinguish between the two nasals. Consistent with this conclusion, the /na/ sound has a nasal murmur as discussed for /ma/. The low pass data shows that when the low pass cutoff frequencies are such that the nasal murmur can be heard but the listener cannot listen to the transition, the score climbs from chance to around 0.5. This is because once the nasal murmur is heard, the sound can be categorized as being nasal and the listener may conclude that the sound is either /ma/ or /na/. Once the transition is also heard, it may be easier to distinguish which of these nasal sounds one is listening to. This may explain the score increase to 1 after the transition is heard. The event strength function indicates that the nasal murmur is a much more robust cue for the nasal sounds since it is seen to be present at SNRs as low as −12 dB. The event strength function also has a peak at around −6 dB SNR, which is where the /ma/ perceptual cue weakens until it is almost completely removed at about −12 dB.

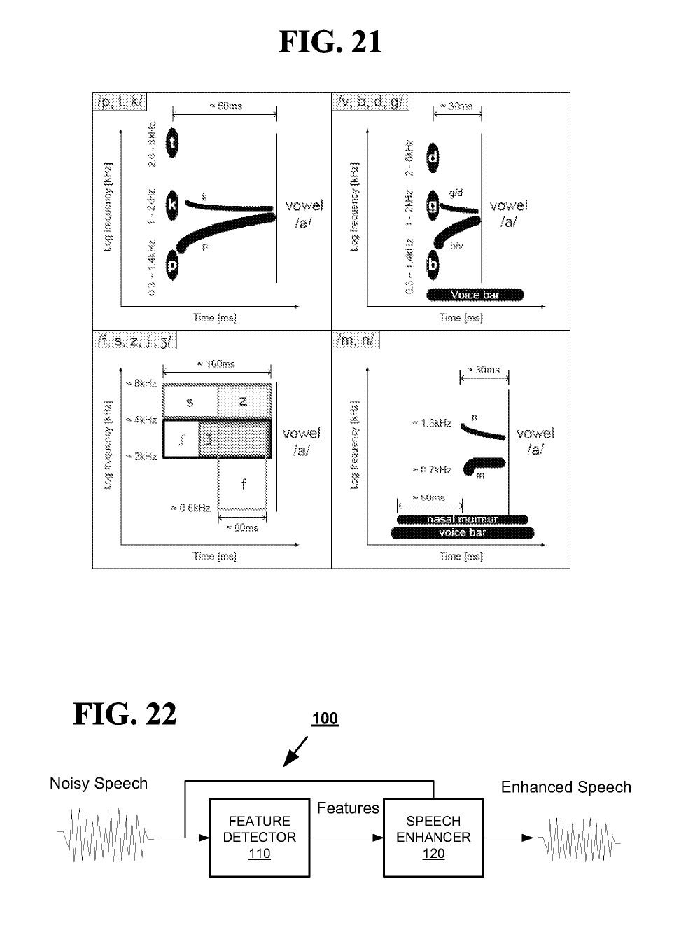

FIG. 21 shows a summary of events relating to initial consonants preceding /a/ as identified by analysis procedures according to embodiments of the invention. The stop consonants are defined by a short duration burst (e.g., about 2 cs), characterized by its center frequency (high, medium and wide band), and the delay to the onset of voicing. This delay, between the burst and the onset of sonorance, is a second parameter called “voiced/unvoiced.” The fricatives (/v/ being an exception) are characterized by an onset of wide-band noise created by the turbulent airflow through lips and teeth. According to an embodiment, duration and frequency range are identified as two important parameters of the events. A voiced fricative usually has a considerably shorter duration than its unvoiced counterpart /θ/ and /δ/ are not included in the schematic drawing because no stable events have been found for these two sounds. The two nasals /m/ and /n/ share a common feature of nasal murmur in the low frequency. As a bilabial consonant, /m/ has a formant transition similar to /b/, while /n/ has a formant transition close to /g/ and /d/.

Sound events as identified according to embodiments of the invention may implicate information about how speech is decoded in the human auditory system. If the process of speech communication is modeled in the framework of information theory, the source of the communication system is a sequence of phoneme symbols, encoded by acoustic cues. At the receiver's side, perceptual cues (events), the representation of acoustic cues on the basilar membrane, are the input to the speech perception center in the human brain. In general, the performance of a communication system is largely dependent on the code of the symbols to be transmitted. The larger the distances between the symbols, the less likely the receiver is prone to make mistakes. This principle applies to the case of human speech perception as well. For example, as previously described /pa, ta, ka/ all have a burst and a transition, the major difference being the position of the burst for each sound. If the burst is missing or masked, most listeners will not be able to distinguish among the sounds. As another example, the two consonants /ba/ and /va/ traditionally are attributed to two different confusion groups according to their articulatory or distinctive features. However, based on analysis according to an embodiment of the invention, it has been shown that consonants with similar events tend to form a confusion group. Therefore, /ba/ and /va/ may be highly confusable to each other simply because they share a common event in the same area. This indicates that events, rather than articulatory or distinctive features, provide the basic units for speech perception.

In addition, as shown by analysis according to embodiments of the invention, the robustness of the consonants may be determined by the strength of the events. For example, the voice bar is usually strong enough to be audible at −18 dB SNR. As a consequence, the voiced and unvoiced sounds are seldom mixed with each other. Among the sixteen consonants, the two nasals, /ma/ and /na/, distinguished from other consonants by the strong event of nasal murmur in the low frequency, are the most robust. Normal hearing people can hear the two sounds without any degradation at −6 dB SNR. Next, the bursts of the stop consonants /ta, ka, da, ga. are usually strong enough for the listeners to hear with an accuracy of about 90% at 0 dB SNR (sometimes −6 dB SNR). Then the fricatives /sa, Sa, za, Za/, represented by some noise bars, varied in bandwidth or duration, are normally strong enough to resist the white noise of 0 dB SNR. Due to the lack of strong dominant cues and the similarity between the events, /ba, va, fa/ may be highly confusable with each other. The recognition score is close to 90% under quiet condition, then gradually drops to less than 60% at 0 dB SNR. The least robust consonants are /Da/ and /Ta/. Both have an average recognition score of less than about 60% at 12 dB SNR. Without any dominant cues, they are easily confused with many other consonants. For a particular consonant, it is common to see that utterances from some of the talkers are more intelligible than those from the other. According to embodiments of the invention, this also may be explained by the strength of the events. In general, utterances with stronger events are easier to hear than the ones with weaker events, especially when there is noise.

In some embodiments, it may be found that speech sounds contain acoustic cues that are conflicting with each other. For example, f103ka contains two bursts in the high- and low-frequency ranges in addition to the mid-frequency /ka/ burst, which greatly increase the probability of perceiving the sound as /ta/ and /pa/ respectively. This is illustrated in panel (d) of FIG. 5. This type of misleading onset may be referred to as an interfering cue.

As previously described, once sound features are identified for one or more sounds, spoken or recorded speech may be enhanced to improve intelligibility of the sounds. FIG. 22 shows a schematic diagram of an example feature-based speech enhancement system according to an embodiment of the invention. In general, the system 100 may include two main components, a feature detector 110 and a speech synthesizer 120. The feature detector 110 may identify a feature in an utterance and provide the feature or information about the feature and the noisy speech as an input to the speech enhancer. The feature detector 110 may use some or all of the methods described herein to identify a sound, or may use stored 3D results for one or more sounds to identify the sounds in spoken speech. For example, the feature detector may store information about one or more sounds and/or confusion groups, and use the stored information to identify those sounds in spoken speech. The feature detector 110 may convert audible speech to a digital form, or may receive a digital representation of the speech from another source, such as a microphone or other transducer. The speech enhancer 120 may then modify the speech data signal provided by the feature detector or the initial speech signal to enhance the audibility or intelligibility of some or all of the speech signal. For example, the speech enhancer 120 may emphasize or de-emphasize the contribution of one or more features to the speech signal to generate a new signal that may have a better intelligibility for the listener. The speech enhancer 120 may provide the modified speech signal to an output, such as a speaker or other audio output, from which a listener may discern the enhanced speech.

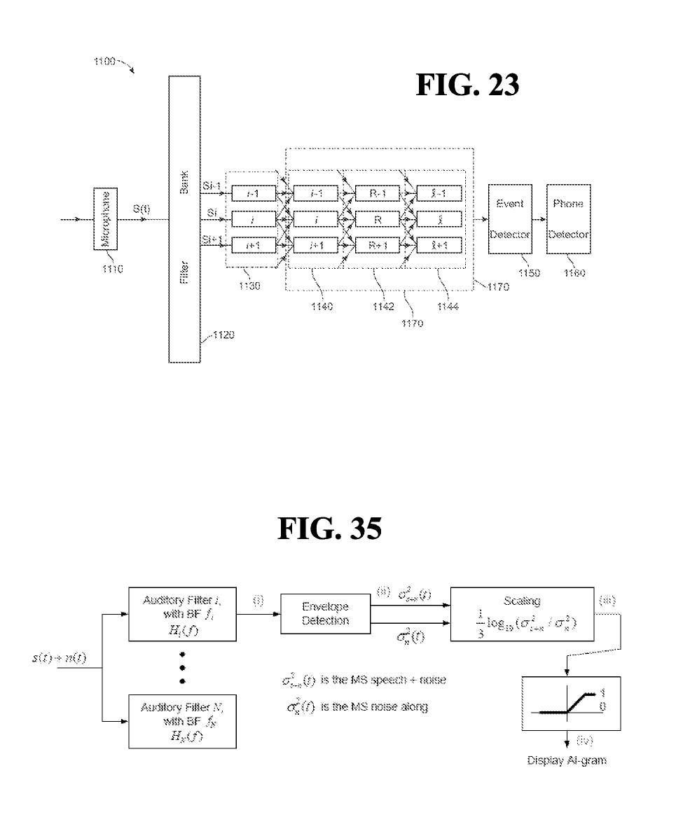

FIG. 23 shows an example of a simplified system for speech sound (phone) detection according to an embodiment of the invention. The system 1100 includes a microphone 1110, a filter bank 1120, onset enhancement devices 1130, a cascade 1170 of across-frequency coincidence detectors, event detector 1150, and a speech sound detector 1160. For example, the cascade of across-frequency coincidence detectors 1170 include across-frequency coincidence detectors 1140, 1142, and 1144. Although the above has been shown using a selected group of components for the system 1100, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification and more particularly below.

The microphone 1110 is configured to receive a speech signal in acoustic domain and convert the speech signal from acoustic domain to an electrical domain s(t). The converted speech signal is received by the filter bank 1120, which can process the converted speech signal and, based on the converted speech signal, generate channel speech signals s₁, . . . , sⱼ, . . . s_{N} in different frequency channels or bands.

The channel speech signals s₁, . . . , sⱼ, . . . s_{N} each fall within a different frequency channel or band. For example, the channel speech signals s₁, . . . , sⱼ, . . . s_{N} fall within, respectively, the frequency channels or bands 1, . . . , j, . . . , N. In one embodiment, the frequency channels or bands 1, . . . , j, . . . , N correspond to central frequencies f₁, . . . , fⱼ, . . . , f_{N}, which are different from each other in magnitude. In another embodiment, different frequency channels or bands may partially overlap, even though their central frequencies are different.

The channel speech signals generated by the filter bank 1120 are received by the onset enhancement devices 1130. For example, the onset enhancement devices 1130 include onset enhancement devices 1, . . . , j, . . . , N, which receive, respectively, the channel speech signals s₁, . . . , sⱼ, . . . s_{N}, and generate, respectively, the onset enhanced signals e₁, . . . , eⱼ, . . . e_{N}. In another example, the onset enhancement devices, i−1, i, and i, receive, respectively, the channel speech signals sᵢ₋₁, sᵢ, sᵢ₊₁, and generate, respectively, the onset enhanced signals eᵢ₋₁, eᵢ, eᵢ₊₁. The onset enhancement devices 1130 are configured to receive the channel speech signals, and based on the received channel speech signals, generate onset enhanced signals, eᵢ₋₁, eᵢ, eᵢ₊₁. The onset enhanced signals can be received by the across-frequency coincidence detectors 1140.

For example, each of the across-frequency coincidence detectors 1140 is configured to receive a plurality of onset enhanced signals and process the plurality of onset enhanced signals. Additionally, each of the across-frequency coincidence detectors 1140 is also configured to determine whether the plurality of onset enhanced signals include onset pulses that occur within a predetermined period of time. Based on such determination, each of the across-frequency coincidence detectors 1140 outputs a coincidence signal. For example, if the onset pulses are determined to occur within the predetermined period of time, the onset pulses at corresponding channels are considered to be coincident, and the coincidence signal exhibits a pulse representing logic “1”. In another example, if the onset pulses are determined not to occur within the predetermined period of time, the onset pulses at corresponding channels are considered not to be coincident, and the coincidence signal does not exhibit any pulse representing logic “1”.

According to an embodiment, each across-frequency coincidence detector i is configured to receive the onset enhanced signals eᵢ₋₁, eᵢ, eᵢ₊₁. Each of the onset enhanced signals includes an onset pulse. In another example, the across-frequency coincidence detector i is configured to determine whether the onset pulses for the onset enhanced signals eᵢ₋₁, eᵢ, eᵢ₊₁ occur within a predetermined period time.

In one embodiment, the predetermined period of time is 10 ms. For example, if the onset pulses for the onset enhanced signals eᵢ₋₁, eᵢ, eᵢ₊₁ are determined to occur within 10 ms, the across-frequency coincidence detector i outputs a coincidence signal that exhibits a pulse representing logic “1” and showing the onset pulses at channels i−1, i, and i+1 are considered to be coincident. In another example, if the onset pulses for the onset enhanced signals eᵢ₋₁, eᵢ, eᵢ₊₁ are determined not to occur within 10 ms, the across-frequency coincidence detector i outputs a coincidence signal that does not exhibit a pulse representing logic “1”, and the coincidence signal shows the onset pulses at channels i−1, i, and i+1 are considered not to be coincident.

The coincidence signals generated by the across-frequency coincidence detectors 1140 can be received by the across-frequency coincidence detectors 1142. For example, each of the across-frequency coincidence detectors 1142 is configured to receive and process a plurality of coincidence signals generated by the across-frequency coincidence detectors 1140. Additionally, each of the across-frequency coincidence detectors 1142 is also configured to determine whether the received plurality of coincidence signals include pulses representing logic “1” that occur within a predetermined period of time. Based on such determination, each of the across-frequency coincidence detectors 1142 outputs a coincidence signal. For example, if the pulses are determined to occur within the predetermined period of time, the outputted coincidence signal exhibits a pulse representing logic “1” and showing the onset pulses are considered to be coincident at channels that correspond to the received plurality of coincidence signals. In another example, if the pulses are determined not to occur within the predetermined period of time, the outputted coincidence signal does not exhibit any pulse representing logic “1”, and the outputted coincidence signal shows the onset pulses are considered not to be coincident at channels that correspond to the received plurality of coincidence signals. According to one embodiment, the predetermined period of time is zero second. According to another embodiment, the across-frequency coincidence detector k is configured to receive the coincidence signals generated by the across-frequency coincidence detectors i−1, i, and i+1.

Furthermore, according to some embodiments, the coincidence signals generated by the across-frequency coincidence detectors 1142 can be received by the across-frequency coincidence detectors 1144. For example, each of the across-frequency coincidence detectors 1144 is configured to receive and process a plurality of coincidence signals generated by the across-frequency coincidence detectors 1142. Additionally, each of the across-frequency coincidence detectors 1144 is also configured to determine whether the received plurality of coincidence signals include pulses representing logic “1” that occur within a predetermined period of time. Based on such determination, each of the across-frequency coincidence detectors 1144 outputs a coincidence signal. For example, if the pulses are determined to occur within the predetermined period of time, the coincidence signal exhibits a pulse representing logic “1” and showing the onset pulses are considered to be coincident at channels that correspond to the received plurality of coincidence signals. In another example, if the pulses are determined not to occur within the predetermined period of time, the coincidence signal does not exhibit any pulse representing logic “1”, and the coincidence signal shows the onset pulses are considered not to be coincident at channels that correspond to the received plurality of coincidence signals. According to one embodiment, the predetermined period of time is zero second. According to another embodiment, the across-frequency coincidence detector 1 is configured to receive the coincidence signals generated by the across-frequency coincidence detectors k−1, k, and k+1.

The across-frequency coincidence detectors 1140, the across-frequency coincidence detectors 1142, and the across-frequency coincidence detectors 1144 form the three-stage cascade 1170 of across-frequency coincidence detectors between the onset enhancement devices 1130 and the event detectors 1150 according to an embodiment of the invention. For example, the across-frequency coincidence detectors 1140 correspond to the first stage, the across-frequency coincidence detectors 1142 correspond to the second stage, and the across-frequency coincidence detectors 1144 correspond to the third stage. In another example, one or more stages can be added to the cascade 1170 of across-frequency coincidence detectors. In one embodiment, each of the one or more stages is similar to the across-frequency coincidence detectors 1142. In yet another example, one or more stages can be removed from the cascade 1170 of across-frequency coincidence detectors.

The plurality of coincidence signals generated by the cascade of across-frequency coincidence detectors can be received by the event detector 1150, which is configured to process the received plurality of coincidence signals, determine whether one or more events have occurred, and generate an event signal. For example, the even signal indicates which one or more events have been determined to have occurred. In another example, a given event represents an coincident occurrence of onset pulses at predetermined channels. In one embodiment, the coincidence is defined as occurrences within a predetermined period of time. In another embodiment, the given event may be represented by Event X, Event Y, or Event Z.

According to one embodiment, the event detector 1150 is configured to receive and process all coincidence signals generated by each of the across-frequency coincidence detectors 1140, 1142, and 1144, and determine the highest stage of the cascade that generates one or more coincidence signals that include one or more pulses respectively. Additionally, the event detector 1150 is further configured to determine, at the highest stage, one or more across-frequency coincidence detectors that generate one or more coincidence signals that include one or more pulses respectively, and based on such determination, also determine channels at which the onset pulses are considered to be coincident. Moreover, the event detector 1150 is yet further configured to determine, based on the channels with coincident onset pulses, which one or more events have occurred, and also configured to generate an event signal that indicates which one or more events have been determined to have occurred.

For example, the event detector 1150 determines that, at the third stage (corresponding to the across-frequency coincidence detectors 1144), there is no across-frequency coincidence detectors that generate one or more coincidence signals that include one or more pulses respectively, but among the across-frequency coincidence detectors 1142 there are one or more coincidence signals that include one or more pulses respectively, and among the across-frequency coincidence detectors 1140 there are also one or more coincidence signals that include one or more pulses respectively. Hence the event detector 1150 determines the second stage, not the third stage, is the highest stage of the cascade that generates one or more coincidence signals that include one or more pulses respectively according to an embodiment of the invention. Additionally, the event detector 1150 further determines, at the second stage, which across-frequency coincidence detector(s) generate coincidence signal(s) that include pulse(s) respectively, and based on such determination, the event detector 1150 also determine channels at which the onset pulses are considered to be coincident. Moreover, the event detector 1150 is yet further configured to determine, based on the channels with coincident onset pulses, which one or more events have occurred, and also configured to generate an event signal that indicates which one or more events have been determined to have occurred.

As discussed above and further emphasized here, FIG. 23 is merely an example, which should not unduly limit the scope of the claims. One of ordinary skill in the art would recognize many variations, alternatives, and modifications. For example, the across-frequency coincidence detectors 1142 are removed, and the across-frequency coincidence detectors 1140 are coupled with the across-frequency coincidence detectors 1144. In another example, the across-frequency coincidence detectors 1142 and 1144 are removed.

In general, according to embodiments of the invention each of the devices shown in FIGS. 22-23 may be used to enhance speech by modifying one or more of the speech sounds previously described, including one or more of /pa, ta, ka, ba, da, ga, fa, θa, sa, ∫a, δa, va, ζa/, combinations thereof, and other sounds. For example, the devices shown in FIGS. 22-23 may be configured to identify the features previously associated with each sound, and thereby locate occurrences of the sounds in spoken speech. Once the sounds are located, the speech may be enhanced by increasing or decreasing the contribution of related features for those sounds that are to be enhanced. For example, the speech may be modified so that a cue relating to a sound to be emphasized or increased gives a higher contribution to the sound heard by a listener. Similarly, the contribution of a cue may be decreased to modify the sound heard by a listener. In some embodiments, the speech may be modified to alter the contribution of one or more features to create “super” sounds, as described in International Application PCT/US2009/49533, filed Jul. 2, 2009, the disclosure of which is incorporated by reference in its entirety.

According to an embodiment of the invention, a hearing aid or other listening device may incorporate one or more of the systems shown in FIGS. 22-23. In such a configuration, the system may enhance specific sounds which a user of the device has particular difficulty discerning. In some cases, the system may allow sounds that the user is able to discern with little or no difficulty to pass through the system unmodified. In a specific embodiment, the system may be customized for a particular user, such as where certain utterances or other aspects of the received signal are enhanced or otherwise manipulated to increase intelligibility according to the user's specific hearing profile.

According to an embodiment of the invention, an Automatic Speech Recognition (ASR) system may be used to process speech sounds. Recent comparisons indicate the gap between the performance of an ASR system and the human recognition system is not overly large. According to Sroka and Braida (2005) ASR systems at +10 dB SNR have similar performance to that of HSR of normal hearing at +2 dB SNR. Thus, although an ASR system may not be perfectly equivalent to a person with normal hearing, it may outperform a person with moderate to serious hearing loss under similar conditions. In addition, an ASR system may have a confusion pattern that is different from that of the hearing impaired listeners. The sounds that are difficult for the hearing impaired may not be the same as sounds for which the ASR system has weak recognition. One solution to the problem is to engage an ASR system when has a high confidence regarding a sound it recognizes, and otherwise let the original signal through for further processing as previously described. For example, a high punishment level, such as proportional to the risk involved in the phoneme recognition, may be set in the ASR.

A device or system according to an embodiment of the invention, such as the devices and systems described with respect to FIGS. 22 and 23, may be implemented as or in conjunction with various devices, such as hearing aids, cochlear implants, telephones, portable electronic devices, automatic speech recognition devices, and other suitable devices. The devices, systems, and components described with respect to FIGS. 22 and 23 also may be used in conjunction or as components of each other. For example, the event detector 1150 and/or phone detector 1160 may be incorporated into or used in conjunction with the feature detector 4810. In other configurations, the speech enhancer 4820 may use data obtained from the system described with respect to FIG. 23 in addition to or instead of data received from the feature detector 4810. Other combinations and configurations will be readily apparent to one of skill in the art.

In some embodiments, the hearing profile of a listener, a type of listener, or a listener population may be used to determine specific sounds that should be enhanced by a speech enhancement or other similar device. A “hearing profile” refers to a definition or description of particular sounds or types of sounds that should be enhanced or suppressed by a speech enhancement device. For example, listeners having different types of hearing impairments may have trouble distinguishing different sounds. In this case, a speech enhancement device may be constructed to selectively enhance those sounds the particular type of listener has trouble distinguishing. Such a device may use a hearing profile to determine which speech sounds should be enhanced. Similarly, a listener population defined by one or more demographics such as age, race, sex, or other attribute may benefit from a particular hearing profile. In some embodiments, an average or ideal hearing profile may be used. In such an embodiment, the hearing deficiencies of a population of listeners may be measured or estimated, and an average hearing profile constructed based on an average hearing deficiency of the population. A hearing profile also may be specific to an individual listener, such as where the individual's hearing is tested and an appropriate profile constructed from the results. Thus, the speech enhancement performed by a device according to the invention may be customized for, or specific to an individual listener, a type of listener, a group or average of listeners, or a listener population.

Experimental Procedures

To perform the multi-dimensional analysis of sounds as described herein, sixty-two listeners were enrolled in a study. Nineteen of the subjects participated in HL07, and nineteen subjects participated in TR07. One subject participated in both of the experiments. The rest of the 24 subjects were assigned to experiment MN05. The large majority of the listeners were undergraduate students, while the remaining were mothers of teenagers. No subject was older than 40 years, and all self reported no history of speech or hearing disorder. All listeners spoke fluent English, with only slight regional accents. Except for two listeners, all the subjects were born in the U.S. with their first language (L1) being English. The subjects were paid for their participation. University IRB approval was attained. The experiment was designed by manually selecting six different utterances per CV consonant, based on the criterion that the samples be representative of the corpus.

The 16 Miller and Nicely (1955) (MN55) CVs /pa, ta, ka, fa, Ta, sa, Sa, ba, da, ga, va, Da, za, Za, ma, na/ were chosen from the University of Pennsylvania's Linguistic Data Consortium (LDC) LDC2005S22 “Articulation Index Corpus,” which were used as the common test material for the three experiments. The speech sounds in the corpus were sampled at 16 kHz using a 16 bit analog to digital converter. Each CV was spoken by 18 talkers of both genders. Additional details regarding the corpus are provided in P. Fousek et al., “New Nonsense Syllables Database—Analyses and Preliminary ASR Experiments,” in Proceedings of International Conference on Spoken Language Processing (ICSLP) (October 2004). Experiment MN05 uses all 18 talkers×16 consonants. For the other two experiments (TR07 and HL07), 6 talkers, half male and half female, each saying each of the 16 MN55 consonants, were manually chosen for the test. These 96 (6 talkers×16 consonants) utterances were selected such that they were representative of the speech material in terms of confusion patterns and articulation score based on the results of earlier speech perception experiment. The speech sounds were presented diotically (same sounds to both ears) through a Sennheisser “HD 280 Pro” headphone, at each listener's “Most Comfortable Level” (MCL) (i.e., between 75 to 80 dB SPL, based on a continuous 1 kHz tone in a homemade 3 cc coupler, as measured with a Radio Shack sound level meter). All experiments were conducted in a single-walled IAC sound-proof booth. All three experiments included a common condition of fullband speech at 12 dB SNR, as a control.

A mandatory practice session was given to each subject at the beginning of the experiment. In each experiment, the general methods were to randomize across all variables when presenting the stimuli to the subjects, other than in MN05 where effort was taken to match previous experimental conditions, as described in S. Phatak, et al., “Consonant confusions in white noise,” J. Acoust. Soc. Am. 124(2), 1220-33 (2008), the disclosure of which is incorporated by reference in its entirety. Following each presentation, subjects responded to the stimuli by clicking on the button labeled with the CV that they heard. In case the speech was heard to be completely masked by the noise, the subject was instructed to click a “Noise Only” button. If the presented token didn't sound like any of the 16 consonants, the subject had the option to either guess one of the 16 sounds, or click the “Noise Only” button. To prevent fatigue, listeners were asked to take frequent breaks, or break whenever they feel tired. Subjects were allowed to play each token up to three times before making their decision, after which the sample was placed in the list, at the end. A Matlab program was created for the control of the three procedures. The audio was played using a SoundBlaster 24 bit sound card in a standard PC Intel computer, running Ubuntu Linux.

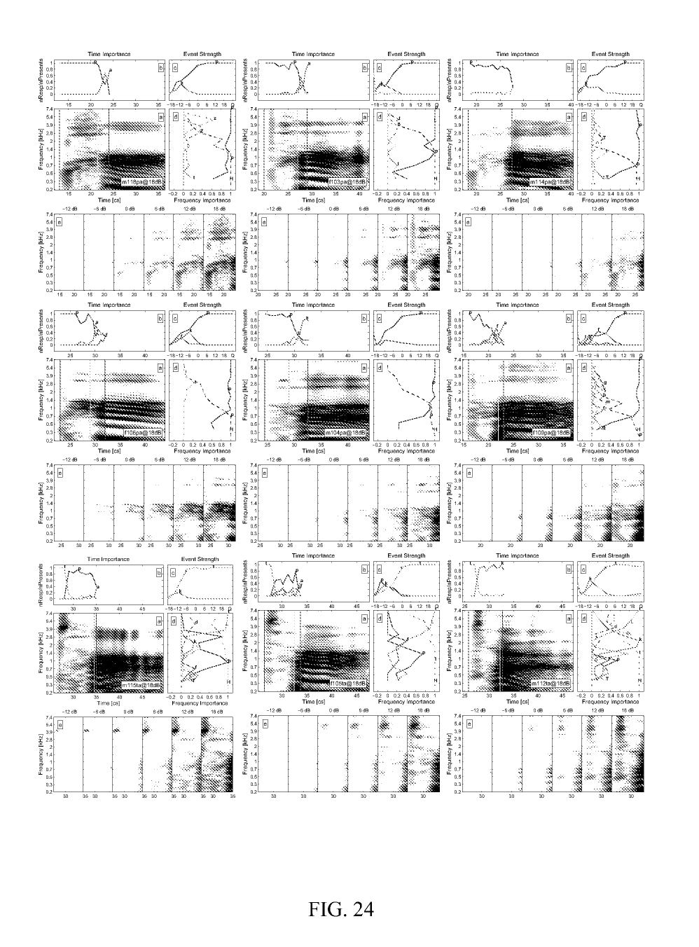

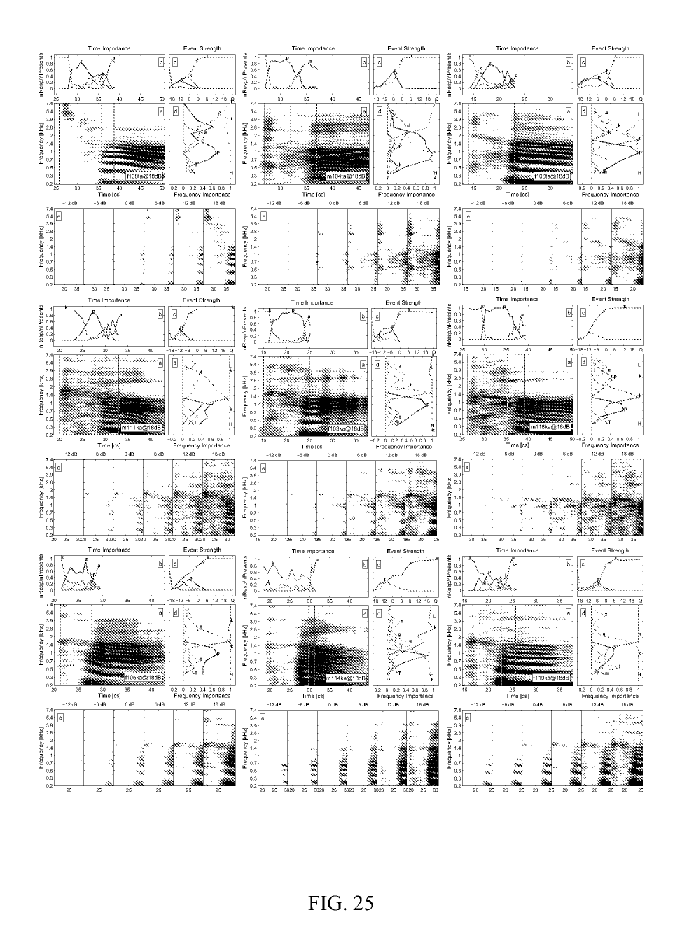

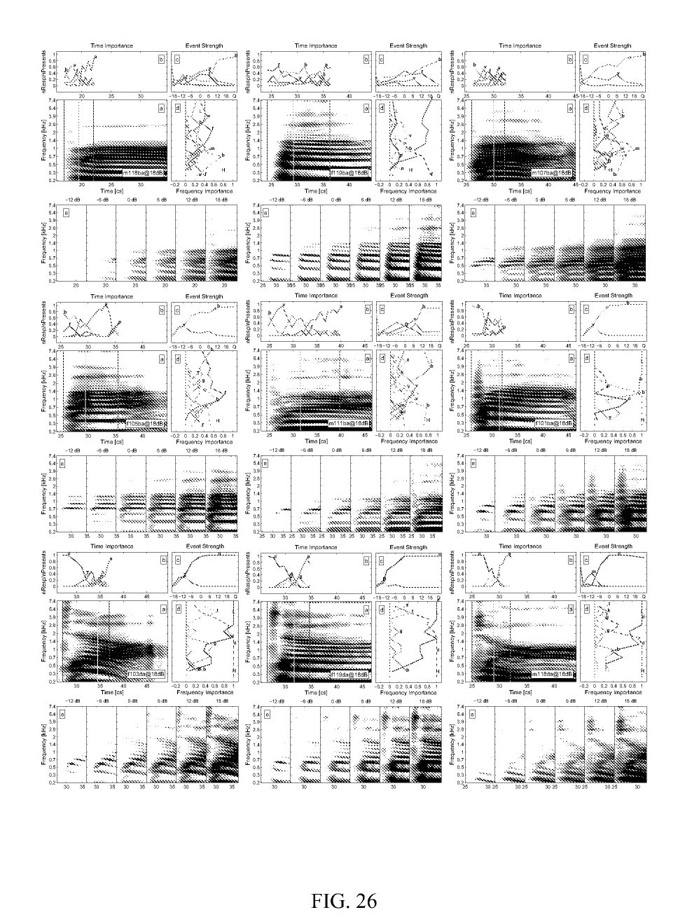

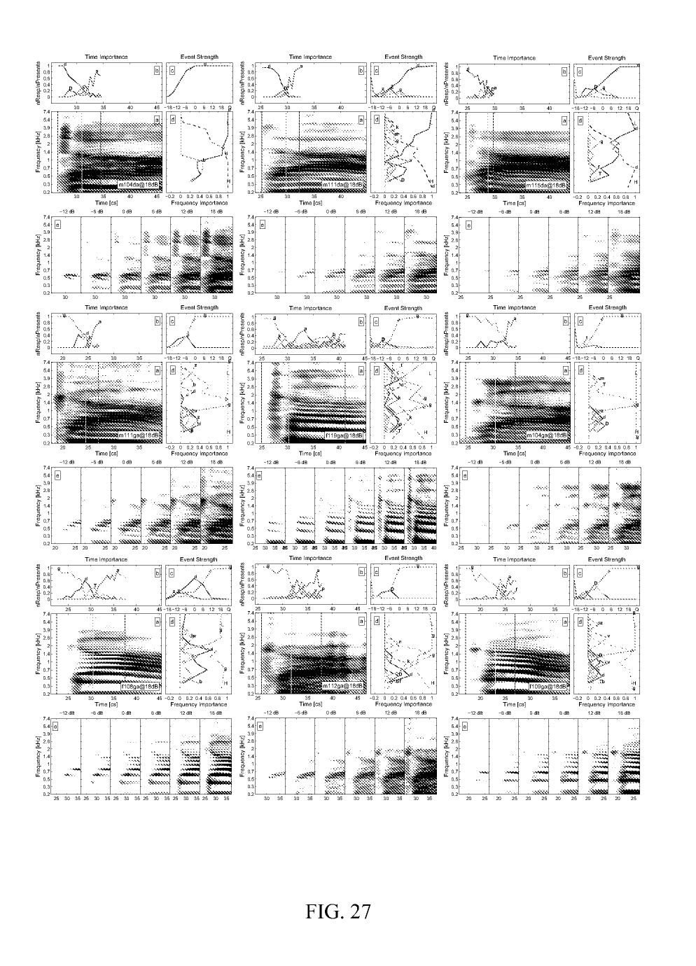

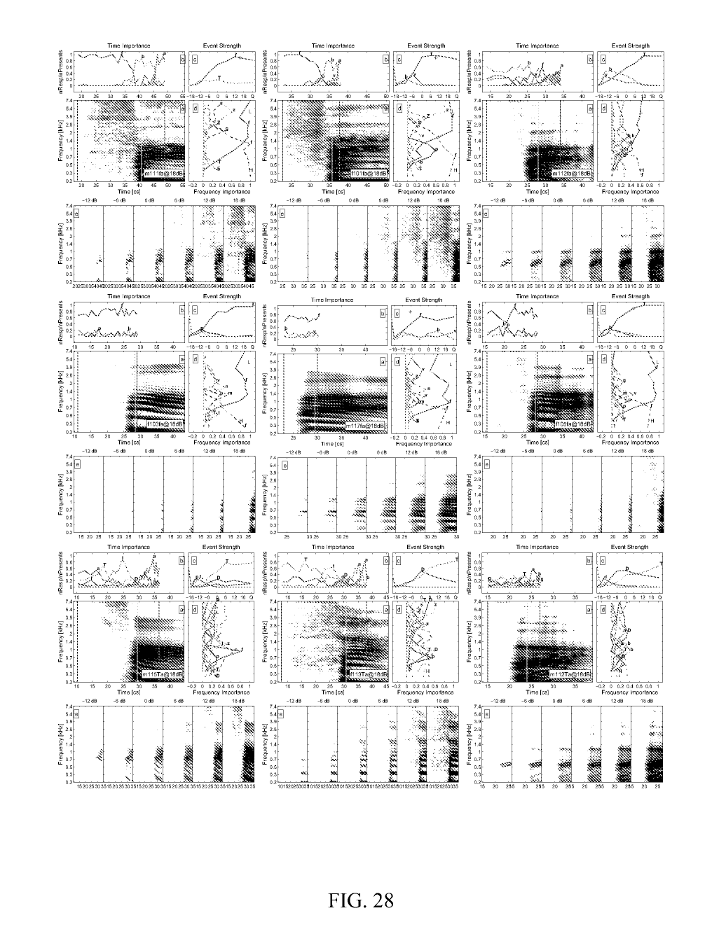

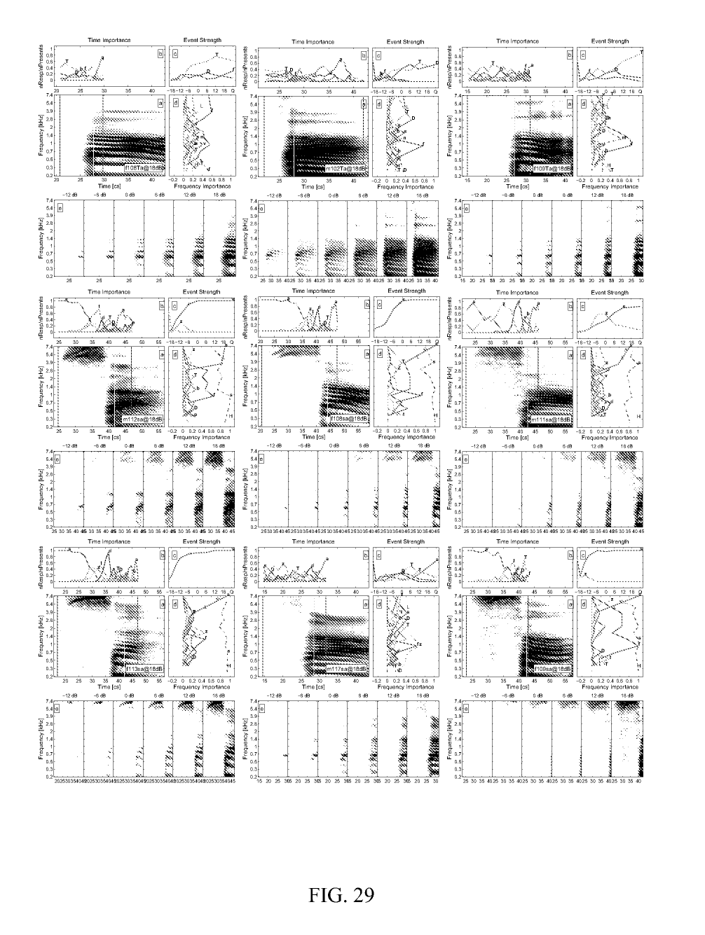

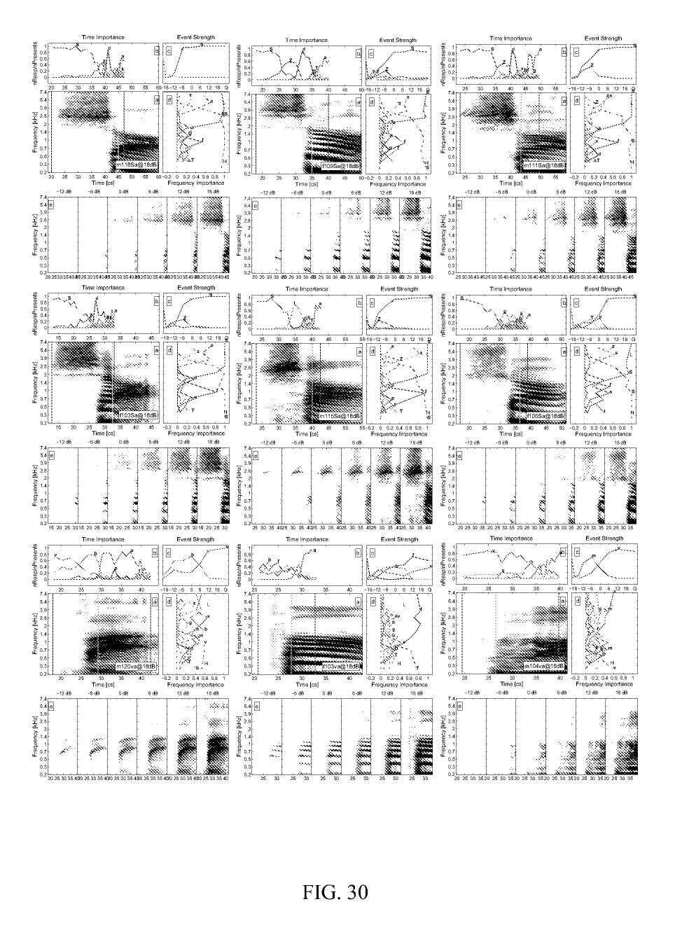

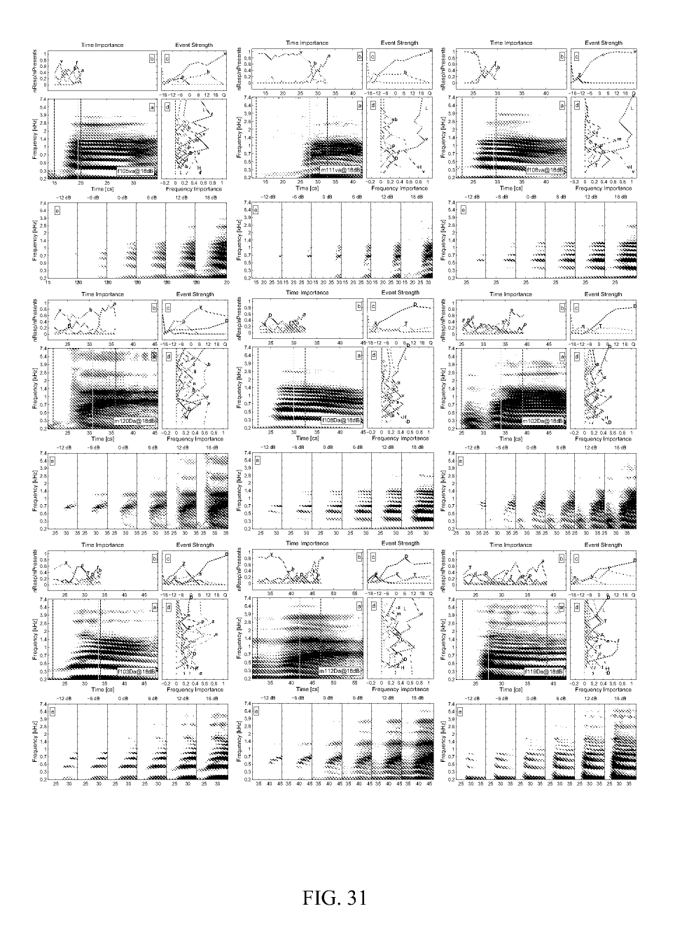

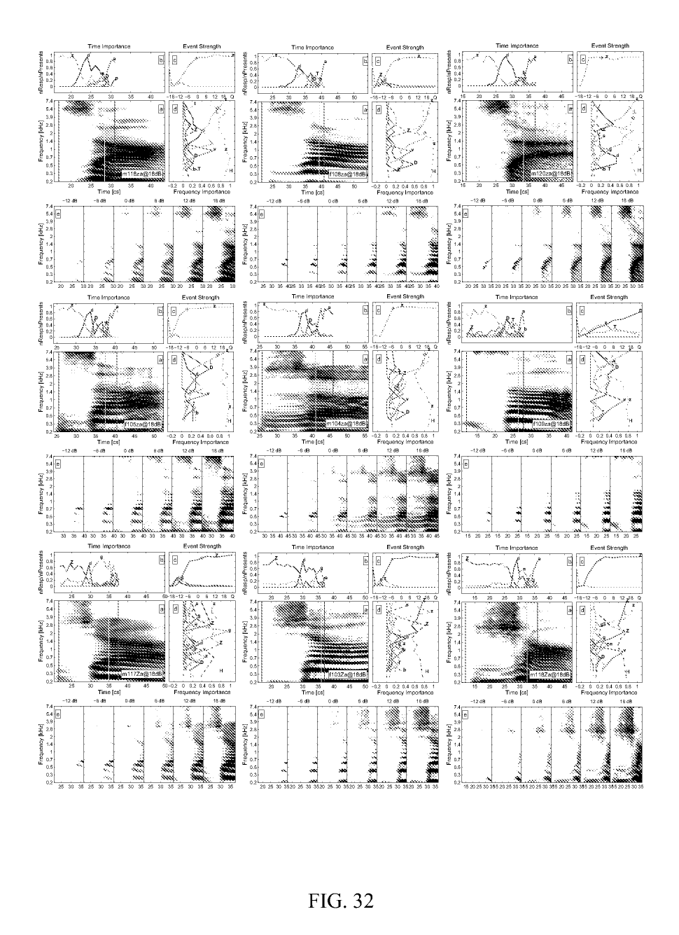

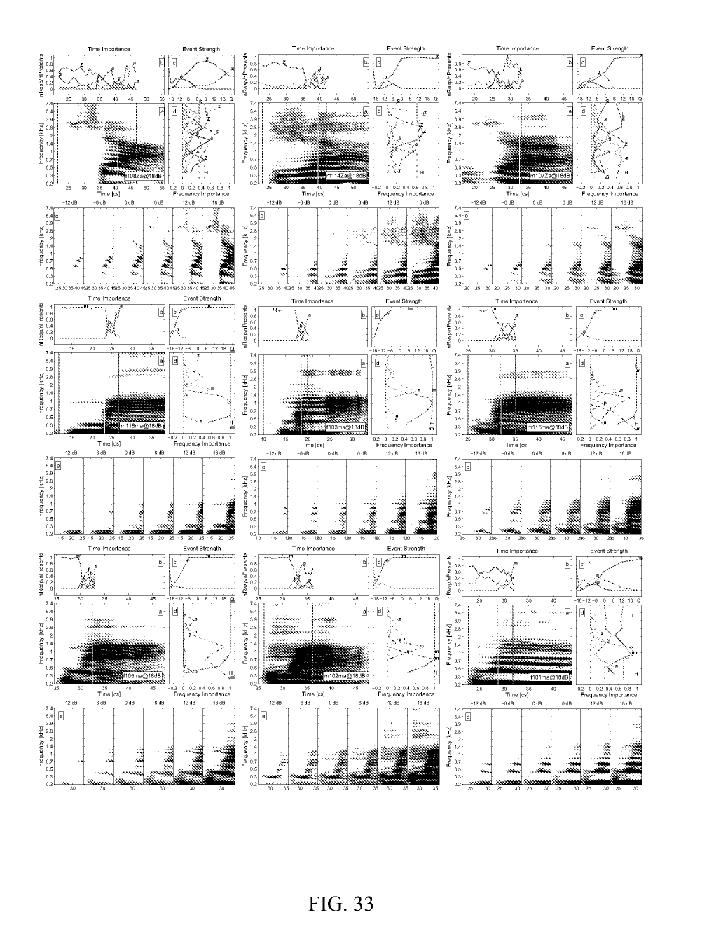

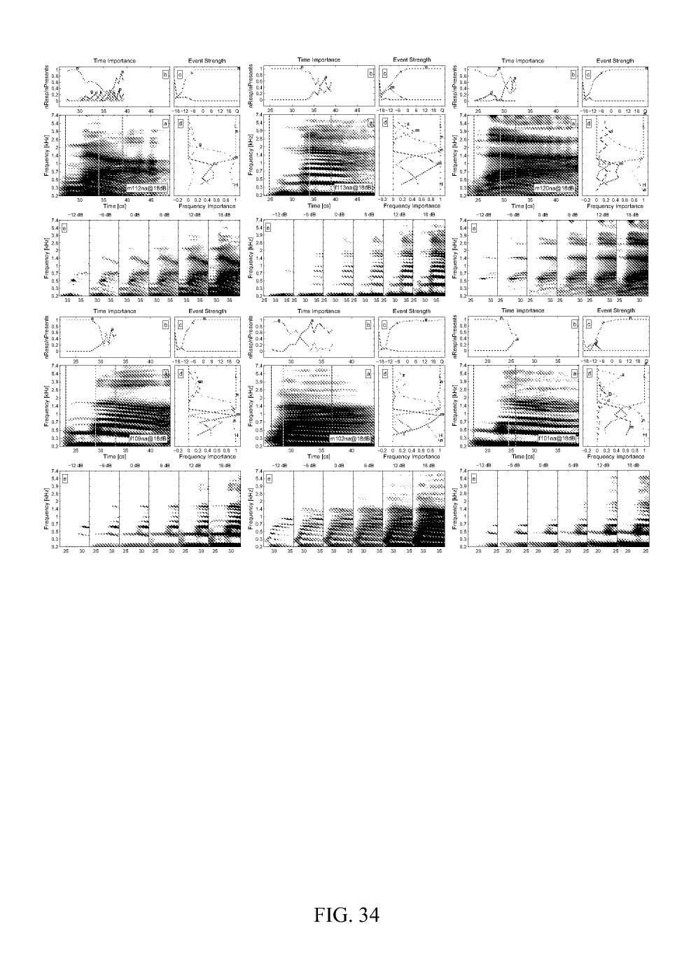

The 3D analysis described herein was applied to each of 96 sounds, using the procedures described above. FIGS. 24-34 show the resulting analyses for each of the sounds according to embodiments of the invention.

The AI Model

Fletcher's AI model is an objective appraisal criterion of speech audibility. The basic concept of AI is that any narrow band of speech frequencies carries a contribution to the total index, which is independent of the other bands with which it is associated and that the total contribution of all bands is the sum of the contribution of the separate bands.

Based on the work of speech articulation over communication systems (Fletcher and Galt, 1950; Fletcher, 1995), French and Steinberg developed a method for the calculation of AI (French and Steinberg, 1947).

$$AI ( S N R ) = \frac{1}{K} {\sum }_{k = 1}^{K} {AI}_{k}$$

where AIₖ is the specific AI for the kth articulation band (Kryter, 1962; Allen, 2005b), and

$${AI}_{k} = min ( \frac{1}{3} {log}_{10} ( 1 + {c}^{2} {snr}_{k}^{2} ) , 1 )$$

where snrₖ is the speech to noise root-mean-squared (RMS) ratio in the k^{th} frequency band and c≈2 is the critical band speech-peak to noise-rms ratio (French and Steinberg, 1947).
Given AI(SNR) for the noisy speech, the predicted average speech error is (Allen, 1994, 2005b)

\hat{e}(AI)=eₘᵢₙ^{AI}·e_{chance}

where eₘᵢₙ is the maximum full-band error when AI=1, and e_{chance} is the probability of error due to uniform guessing Allen (2005b).

The AI-gram

The AI-gram is the integration of the Fletcher's AI model and a simple linear auditory model filter-bank [i.e., Fletcher's SNR model of detection (Allen, 1996)]. FIG. 35 depicts a schematic block diagram of a system to generate an AI-gram. Once the speech sound reaches the cochlea, it is decomposed into multiple auditory filter bands, followed by an “envelope” detector. Fletcher-audibility of the narrow-band speech is predicted by the formula of specific AI. A time-frequency pixel of the AIgram (a two-dimensional image) is denoted AI(t; f), where t and f are the time and frequency respectively. The implementation used here quantizes time to 2.5 [ms], and uses 200 frequency channels, uniformly distributed in place according to the Greenwood frequency-place map of the cochlea, with bandwidths according to the critical bandwidth of Fletcher (1995).

The average of the AI-gram over time and frequency, and then averaged over a phonetically balanced corpus, yields a quantity numerically close to the AI as described by Allen. An average across frequency at the output of the AI-gram yields the instantaneous AI

$$a ( {t}_{n} ) = {\sum }_{k} AI ( {t}_{n} , {f}_{k} )$$

at time tₙ.

Given a speech sound, AI-gram model provides an approximate “visual detection threshold” of the audible speech components available to the central auditory system. It is silent on which component are relevant to the speech event. To determine the relevant cues, the results of speech perception experiments (events) may be correlated with the associated AI-grams.

Examples provided herein are merely illustrative and are not meant to be an exhaustive list of all possible embodiments, applications, or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the relevant arts or fields are intended to be within the scope of the appended claims. As a specific example, one of skill in the art will understand that any appropriate acoustic transducer may be used instead of or in conjunction with a microphone. As another example, various special-purpose and/or general-purpose processors may be used to implement the methods described herein, as will be understood by one of skill in the art.

The disclosures of all references and publications cited above are expressly incorporated by reference in their entireties to the same extent as if each were incorporated by reference individually.

What is claimed is:

1. A method of locating a sound feature within a speech sound, said method comprising:
iteratively truncating the speech sound to identify a time at which the feature occurs in the speech sound;
applying at least one frequency filter to identify a frequency range in which the feature occurs in the speech sound;
masking the speech sound to identify a relative intensity at which the feature occurs in the speech sound; and
using at least two of the identified time, frequency range, and intensity to locate the sound feature within the speech sound.

2. The method of claim 1, said step of iteratively truncating the speech sound further comprising:
truncating the speech sound at a plurality of step sizes from the onset of the speech sound;
measuring listener recognition after each truncation; and
upon finding a truncation step size at which the speech sound is not distinguishable by the listener, identifying the step size as indicating the location of the sound feature in time.

3. The method of claim 2, said plurality of step sizes comprising 5 ms, 10 ms, and 20 ms.

4. The method of claim 1, said step of applying at least one frequency filter comprising:
applying a series of highpass cutoff frequencies, lowpass cutoff frequencies, or both to the speech sound;
measuring listener recognition after each filtering; and
upon finding a cutoff frequency at which the speech sound is not distinguishable by the listener, identifying the frequency range defined by the cutoff frequency and a prior cutoff frequency as indicating the frequency range of the sound feature.

5. The method of claim 4, wherein the highpass cutoff frequencies comprise 6185, 4775, 3678, 2826, 2164, 1649, 1250, 939, and 697 Hz.

6. The method of claim 4, wherein the lowpass cutoff frequencies comprise 3678, 2826, 2164, 1649, 1250, 939, 697, 509, and 363 Hz.

7. The method of claim 1, said step of masking the speech sound further comprising:
applying white noise to the speech sound at a series of signal-to-noise ratios (SNRs);
measuring listener recognition after each application of white noise; and
upon finding a SNR at which the speech sound is not distinguishable by the listener, identifying the SNR as indicating the intensity of the sound feature.

8. The method of claim 7, wherein the SNRs comprise −21, −18, −15, −12, −6, 0, 6, and 12 dB.

9. The method of claim 1, wherein the speech sound comprises at least one of /pa, ta, ka, ba, da, ga, fa, θa, sa, ∫a, δa, va, ζa/.

10. The method of claim 1, further comprising:
generating speech sound modification information sufficient to allow a speech enhancing device to modify the speech sound based on the location of the feature in a portion of spoken speech.

11. The method of claim 1, further comprising:
receiving a spoken speech sound;
based on the identified location of the sound feature, locating the corresponding speech sound within the spoken speech sound; and
enhancing the spoken speech sound to improve the recognizability of the speech sound within the spoken speech sound for a listener.

12. The method of claim 11, wherein said step of enhancing is performed based on a hearing profile of an individual listener.

13. The method of claim 11, wherein said step of enhancing is performed based on a hearing profile of listener population.

14. The method of claim 11, wherein said step of enhancing is performed based on a hearing profile of a listener type.

15. The method of claim 11, wherein said step of enhancing is performed based on a hearing profile generated from hearing data for a plurality of listeners.

16. A method for enhancing a speech sound, said method comprising:
identifying a first feature in the speech sound that encodes the speech sound, the location of the first feature within the speech sound being defined by feature location data generated by an analysis of at least two dimensions of the speech sound; and
increasing the contribution of the first feature to the speech sound.

17. The method of claim 16, further comprising: generating speech sound modification information sufficient to allow a speech enhancing device to increase the contribution of the first feature to the speech sound.

18. The method of claim 16, wherein the at least two dimensions comprise at least two of time, frequency, and intensity.

19. The method of claim 16, said method further comprising:
identifying a second feature in the speech sound that interferes with the speech sound; and
decreasing the contribution of the second feature to the speech sound.

20. The method of claim 16, said step of identifying the first feature in the speech sound further comprising:
isolating a section of a reference speech sound corresponding to the speech sound to be enhanced within at least one of a time range, a frequency range, and an intensity;
based on the degree of recognition among a plurality of listeners to the isolated section, constructing an importance function describing the contribution of the isolated section to the recognition of the speech sound; and
using the importance function to identify the first feature as encoding the speech sound.

21. The method of claim 16, said step of identifying the first feature further comprising:
iteratively truncating the speech sound to identify a time at which the feature occurs in the speech sound;
applying at least one frequency filter to identify a frequency range in which the feature occurs in the speech sound;
masking the speech sound to identify a relative intensity at which the feature occurs in the speech sound; and
using the identified time, frequency range, and intensity to identify the sound feature within the speech sound.

22. The method of claim 16, the speech sound comprising at least one of /pa, ta, ka, ba, da, ga, fa, θa, sa, ∫a, δa, va, ζa/.

23. A system comprising:
a feature detector configured to identify a first feature within a spoken speech sound in a speech signal;
a speech enhancer configured to enhance said speech signal by modifying the contribution of the first feature to the speech sound; and
an output to provide the enhanced speech signal to a listener.

24. The system of claim 23, the speech enhancer configured to enhance said speech signal based on a hearing profile of the listener.

25. The system of claim 24, wherein the hearing profile is a hearing profile of an individual listener.

26. The system of claim 24, wherein the hearing profile is a hearing profile of a listener population.

27. The system of claim 24, wherein the hearing profile is a hearing profile of a listener type.

28. The system of claim 24, wherein the hearing profile is generated from hearing data for a plurality of listeners.

29. The system of claim 23, said feature detector storing speech feature data generated by a method comprising:
iteratively truncating the speech sound to identify a time at which the feature occurs in the speech sound;
applying at least one frequency filter to identify a frequency range in which the feature occurs in the speech sound;
masking the speech sound to identify a relative intensity at which the feature occurs in the speech sound; and
using at least two of the identified time, frequency range, and intensity to locate the sound feature within the speech sound.

30. The system of claim 23, wherein modifying the contribution of the first feature to the speech sound comprises decreasing the contribution of the first feature.

31. The system of claim 23, wherein modifying the contribution of the first feature to the speech sound comprises increasing the contribution of the first feature.

32. The system of claim 31, said speech enhancer further configured to enhance the speech signal by decreasing the contribution of a second feature to the speech sound, wherein the second feature interferes with recognition of the speech sound by the listener.

33. The system of claim 23, wherein the speech enhancer is configured to enhance the speech signal based on a hearing profile of the listener.

34. The system of claim 23, wherein the feature detector is configured to identify the first feature based on a hearing profile of the listener.

35. The system of claim 23, said system being implemented in a device selected from the group of a hearing aid, a cochlear implant, a telephone, a portable electronic device, and an automated speech recognition device.

36. The system of claim 23, the speech sound comprising at least one of /pa, ta, ka, ba, da, ga, fa, θa, sa, ∫a, δa, va, ζa/.

37. The system of claim 23, further comprising a plurality of filter banks to filter the speech signal.

38. The system of claim 23, further comprising a plurality of feature detectors, each feature detector configured to detect a different speech sound feature.

39. The system of claim 23, further comprising an audio transducer to receive the speech signal.
